(19) United States
(12) Patent Application Publication
(10) Pub. No.: US 2025/0307669 A1
(43) Pub. Date: Oct. 2, 2025

(54) Framework for Artificial-Intelligence-Based Automation

(71) Applicant: Atera Networks Ltd, Tel Aviv (IL)

(72) Inventors: Oshri MOYAL, Yavne (IL); Bar Maltabashi, Rehovot (IL); Elad Shmuel ELRAM, Sansana (IL)

(21) Appl. No.: 19/234,999

(22) Filed: Jun. 11, 2025

Related U.S. Application Data
(63) Continuation-in-part of application No. 18/383,947, filed on Oct. 26, 2023, now Pat. No. 12,388,727.

(51) Int. Cl. G06N 5/025

(52) U.S. Cl. CPC G06N 5/025

(57) ABSTRACT

A method includes receiving a first user input and automatically determining whether the first user input indicates a technical issue. The method includes automatically determining, using at least one machine learning model, whether the technical issue is associated with a database entry. The method includes, in response to a determination that the technical issue is associated with a database entry, automatically identifying at least one action set. The method includes, in response to detecting a second input, coordinating execution of the at least one action set, including remotely executing a series of one or more actions. The method includes, in response to a determination that the technical issue is not associated with the one or more entries in the database, detecting a third user input, recording the third user input, analyzing the recording of the third user input, and creating an entry in the database.

### CROSS-REFERENCE TO RELATED APPLICATIONS

This application is a continuation-in-part of U.S. patent application Ser. No. 18/383,947 filed Oct. 26, 2023. The entire disclosure of the above application is incorporated by reference.

### FIELD

The present disclosure relates to distributed computing devices and more particularly to computer-based automation.

### BACKGROUND

In an environment filled with computers, a user of a computer may encounter various incidents with the user's computer. For example, the user may be unable to save a file to a network hard drive, unable to print a document, unable to launch a particular application, etc. The user may contact an information technology (IT) technician, who may have the knowledge and resources to resolve the incident. However, the technician may be unavailable to provide immediate assistance to the user, such as when the technician is assisting other users, the incident arises outside of normal business hours, etc.

Once the technician becomes available to provide assistance, the technician must request and be granted permission from the user before remotely connecting to the user's computer. The technician may perform a set of actions in order to resolve the user's incident. Many of the issues resolved by technicians are repetitive, requiring technicians to perform the same actions repeatedly.

To mitigate this, some IT professionals attempt to automate routine tasks. However, identifying and implementing automation requires significant time and effort. Automation often takes the form of scripts executed on demand when specific issues arise, knowledge bases containing troubleshooting instructions, and organizational processes that end-users can access via a user portal.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method includes receiving a first user input from a first user associated with a first computer system. The method includes automatically determining, using at least one of a set of machine learning models, whether the first user input indicates a technical issue associated with the first computer system. The method includes automatically determining, using at least one model of the set of machine learning models, whether the technical issue is associated with one or more entries in a database. The method includes, in response to a determination that the technical issue is associated with the one or more entries in the database, automatically identifying at least one action set associated with the technical issue. The method includes, in response to detecting a second input from the first user, coordinating execution of the at least one action set on the first computer system, including remotely executing a series of one or more actions specified by the at least one action set. The method includes, in response to a determination that the technical issue is not associated with the one or more entries in the database, detecting a third user input from a second user, recording the third user input, analyzing, using at least one model of the set of machine learning models, the recording of the third user input, and creating an entry in the database including a set of data based on the third user input.

In other features, the third user input includes a solution to the technical issue. In other features, the third user input includes a set of interactions with the first computer system. In other features, the set of data based on the third user input includes at least one of at least a second action set, a set of communication data associated with the first user and the second user, or a plain-text description of the third user input.

In other features, the at least one action set includes an executable script or function. In other features, the at least one action set includes transmitting a set of instructions including a request to execute an executable script or function to a second computer system.

In other features, the method includes summarizing, using at least one model of the set of machine learning models, the first user input, and retrieving a set of historical data related to the first user. In other features, the technical issue is associated with the one or more entries in the database. In other features, the method includes determining whether the at least one action set resolved the technical issue.

In other features, the technical issue is not associated with the one or more entries in the database. In other features, the method includes determining whether the third user input resolved the technical issue. In other features, the third user input is received via a second computer system with a remote connection to the first computer system.

A system includes memory hardware configured to store instructions, and processor hardware configured to execute the instructions. The instructions include receiving a first user input from a first user associated with a first computer system. The instructions include automatically determining, using at least one of a set of machine learning models, whether the first user input indicates a technical issue associated with the first computer system. The instructions include automatically determining, using at least one model of the set of machine learning models, whether the technical issue is associated with one or more entries in a database. The instructions include, in response to a determination that the technical issue is associated with the one or more entries in the database, automatically identifying at least one action set associated with the technical issue. The instructions include, in response to detecting a second input from the first user, coordinating execution of the at least one action set on the first computer system, including remotely executing a series of one or more actions specified by the at least one action set. The instructions include, in response to a determination that the technical issue is not associated with the one or more entries in the database, detecting a third user input from a second user, recording the third user input, analyzing, using at least one model of the set of machine learning models, the recording of the third user input, and creating an entry in the database including a set of data based on the third user input.

In other features, the third user input includes a solution to the technical issue. In other features, the third user input includes a set of interactions with the first computer system. In other features, the set of data based on the third user input includes at least one of at least a second action set, a set of communication data associated with the first user and the second user, or a plain-text description of the third user input.

In other features, the at least one action set includes an executable script or function. In other features, the at least one action set includes transmitting a set of instructions including a request to execute an executable script or function to a second computer system.

In other features, the instructions include summarizing, using at least one model of the set of machine learning models, the first user input, and retrieving a set of historical data related to the first user. In other features, the technical issue is associated with the one or more entries in the database. In other features, the instructions include determining whether the at least one action set resolved the technical issue.

In other features, the technical issue is not associated with the one or more entries in the database. In other features, the instructions include determining whether the third user input resolved the technical issue. In other features, the third user input is received via a second computer system with a remote connection to the first computer system.

A non-transitory computer-readable storage medium stores processor-executable instructions. The instructions include receiving a first user input from a first user associated with a first computer system. The instructions include automatically determining, using at least one of a set of machine learning models, whether the first user input indicates a technical issue associated with the first computer system. The instructions include automatically determining, using at least one model of the set of machine learning models, whether the technical issue is associated with one or more entries in a database. The instructions include, in response to a determination that the technical issue is associated with the one or more entries in the database, automatically identifying at least one action set associated with the technical issue. The instructions include, in response to detecting a second input from the first user, coordinating execution of the at least one action set on the first computer system, including remotely executing a series of one or more actions specified by the at least one action set. The instructions include, in response to a determination that the technical issue is not associated with the one or more entries in the database, detecting a third user input from a second user, recording the third user input, analyzing, using at least one model of the set of machine learning models, the recording of the third user input, and creating an entry in the database including a set of data based on the third user input.

In other features, the third user input includes a solution to the technical issue. In other features, the third user input includes a set of interactions with the first computer system. In other features, the set of data based on the third user input includes at least one of at least a second action set, a set of communication data associated with the first user and the second user, or a plain-text description of the third user input.

In other features, the at least one action set includes an executable script or function. In other features, the at least one action set includes transmitting a set of instructions including a request to execute an executable script or function to a second computer system.

In other features, the instructions include summarizing, using at least one model of the set of machine learning models, the first user input, and retrieving a set of historical data related to the first user. In other features, the technical issue is associated with the one or more entries in the database. In other features, the instructions include determining whether the at least one action set resolved the technical issue.

In other features, the technical issue is not associated with the one or more entries in the database. In other features, the instructions include determining whether the third user input resolved the technical issue. In other features, the third user input is received via a second computer system with a remote connection to the first computer system.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a flowchart of an example process of automatically resolving IT issues using machine learning models.

FIGS. 2A-2B are schematic illustrations of an example system for automatically resolving IT issues using machine learning models.

FIG. 3 is a schematic illustration of example building blocks of a system for automatically resolving IT issues using machine learning models.

FIGS. 4-7 are schematic illustrations of example designs of a system for automatically resolving IT issues using machine learning models.

FIG. 8 is a functional block diagram of an example system for artificial-intelligence based automation.

FIG. 9 is a flowchart of an example automation for analyzing a technician-assistance session.

FIG. 10 is a flowchart of an example specialist AI agent flow.

FIG. 11 is a flowchart of an example method for an end-user automation framework.

FIG. 12 is a flowchart of an example method for a technician user automation framework.

In the drawings, reference numbers may be reused to identify similar and/or identical elements.

### DETAILED DESCRIPTION

### Introduction

According to the present disclosure, a distributed computing system can generate, trigger, and execute artificial-intelligence-based (AI-based) automations. Specialist AI agents can be assigned tasks (such as ticket annotation, service rating, IT-assistance session analysis, and/or knowledge base creation and updating) based on various triggers (such as the closing of a service ticket, ending a remote connection session, etc.).

A set of predefined triggers and actions executed by the specialist AI agents is called a flow. In various embodiments, flows have specific execution conditions, such as running only for specific accounts (based on authorization level or other criteria), licenses, or account types. Each flow begins with a trigger, followed by one or more actions. In various embodiments, a flow includes a set of plain-text instructions which are interpreted by a Large Language Model (LLM) and translated into computer executable instructions. In various embodiments, the flow executes predefined functions, resolution profiles, or scripts based on the plain-text instructions. In various embodiments, a flow instructs an LLM to perform one or more determinations or determinations that are based on predefined functions (for example, determining whether user feedback regarding a knowledge article or resolution profile is positive or negative and performing different actions based on the result).

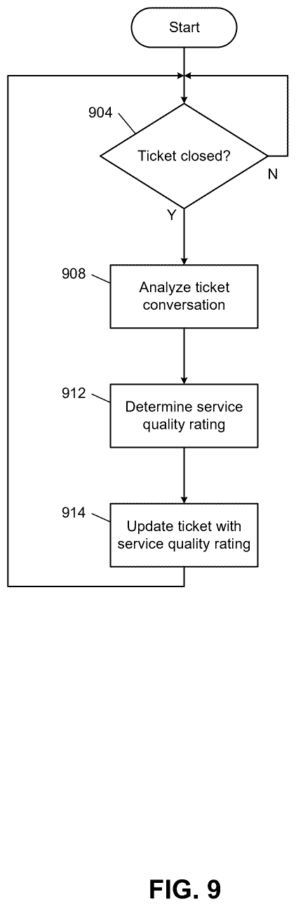

Specialist AI agents interact with LLMs, machine learning models, and/or neural networks by running predefined prompts and returning structured results. In various embodiments, an AI agent includes a prompt definition (a predefined instruction specifying the task), injected data (relevant context for the task such as ticket conversation history), and output schema (a structured format for the result). For example, as depicted in FIG. 9, if a ticket closure triggers a flow, an AI agent evaluates the quality of service provided by the technician. The ticket conversation history is used as input, and the AI assigns a service quality score. In various embodiments, specialist AI agents run continuously, waiting for the associated trigger to be detected.

### AI Resolution Profiles

The present invention, in some embodiments thereof, relates to resolving IT issues related to remote client devices, and, more specifically, but not exclusively, to using AI for automatically resolving IT issues related to remote client devices.

In various embodiments of the present invention, there are provided methods, systems, devices, and computer software programs for automatically resolving IT issues related to one or more client devices, such as, a desktop, a laptop, a server, a smartphone, a tablet, a smart watch, a proprietary client device and/or the like.

In particular, AI in the form of one or more Machine Learning (ML) models is used to identify, determine, and/or generate solutions for resolving one or more of the IT issues related to the client devices.

A remote IT assistance system, typically a cloud-based system, may use one or more ML models, for example, a neural network, a classifier, a statistical classifier, a Support Vector Machine (SVM), and/or the like adapted to automatically determine and/or generate one or more resolution profiles comprising a set of actions implementing one or more solutions estimated to resolve each of a plurality of IT issues related to one or more of the client devices.

Optionally, the IT assistance system may access one or more pre-trained generative ML models, for example, ChatGPT, Bard, Gemini, and/or the like which may be prompted to compute resolution profiles for resolving one or more IT issues related to one or more of the client devices.

The ML models may determine and/or generate the resolution profiles based on analysis of system data related to each IT issues of a respective client device that may be collected from the client device and/or from one or more services and/or infrastructures serving the client device.

The system data may include, for example, informative data collected by local IT assistance agent executed by the respective client device which may comprise, for example, one or more operational parameters related to one or more of a plurality of functional components of the respective client device, for example, hardware components, software components, and/or a combination thereof. In another example, the system data may include informative data and/or service data collected from one or more remote services and/or one or more of infrastructure systems serving the respective client device.

The system data may further comprise user behavior data collected by the local IT assistance agent, for example, user interaction with Human Machine Interfaces (HMI) of the respective client device, resources (for example, screens, web pages, applications, menus, etc.) accessed by a user of the respective client device, items selected, clicked, and/or pointed at by the user, and/or the like. The system data may also include user input provided by the user of the respective client device, specifically user input provided in relation to one or more IT issues related to the respective client device.

The system data related to each IT issue may be injected into the ML model(s) which may identify one or more root causes of the IT issue according to learned system data patterns and may generate accordingly one or more resolution profiles that implement one or more solutions estimated to effectively resolve the respective IT issue.

One or more of the ML model(s) may be trained using one or more training datasets associating system datasets related to a plurality of IT issues with respective resolution profiles which resolve the IT issues, for example, resolution profiles used in the past and proved to resolve the IT issues, resolution profiles defined by one or more experts (for example, IT personnel, IT professional, etc.), and/or the like. In various embodiments, the ML model(s) are trained on manually-created knowledge base articles and/or automatically-created knowledge based articles.

However, optionally, the ML model(s) may comprise one or more generative ML models which, rather than identifying predefined resolution profiles, may generate resolution profiles based on a learned knowledge base of system data and IT resolution methods, techniques, protocols, and/or experience. In various embodiments, a resolution profile is tailored to a specific organization (for example, with specific organization information) and is difficult to adapt as a generic solution. As described in below, AI specialist agents can adapt a resolution profile for generic use and/or for use with a second organization and are deployable as generic automation system.

Automatically resolving IT issues for client devices may present major benefits and advantages over currently existing IT support methods and systems. First, most if not all current IT support methods heavily rely on manual skills, expertise, experience, and/or labor of human IT people, technicians and/or experts. Manual IT support methods may present major limitations in terms of response time, resolution time, scalability, to name just a few due to limited human professional IT resources and the inherent limitations of human capacity to analyze large volumes of system data.

Automatically resolving IT issues related to a plurality of client devices may efficiently overcome the limitations of the existing methods since it may efficiently resolve IT issues automatically with no human intervention. As such, since there is no need to wait for available IT human resources, IT issues may be quickly resolved with a short response time. Also, because the IT issues are resolved automatically using high performance computing resources applied to analyze the system data, identifying, determining and/or generating resolution profiles for resolving the IT issues may be done extremely fast thus further reducing the overall response time for resolving the IT issues.

Moreover, automatically resolving IT issues may be highly scalable to support huge numbers of client devices since the remote IT assistance system, typically implemented via cloud resources, may be easily scaled to employ changing amounts of computing resources, ML resources, and/or the like according to changes in demand for IT assistance.

Furthermore, applying generative ML models may to generate resolution profiles for resolving IT issues may yield efficient resolution profiles not previously used and/or devised thus improving performance and/or scope of the automated IT support and also expanding the IT support domain.

### Example Process for Resolving it Issues

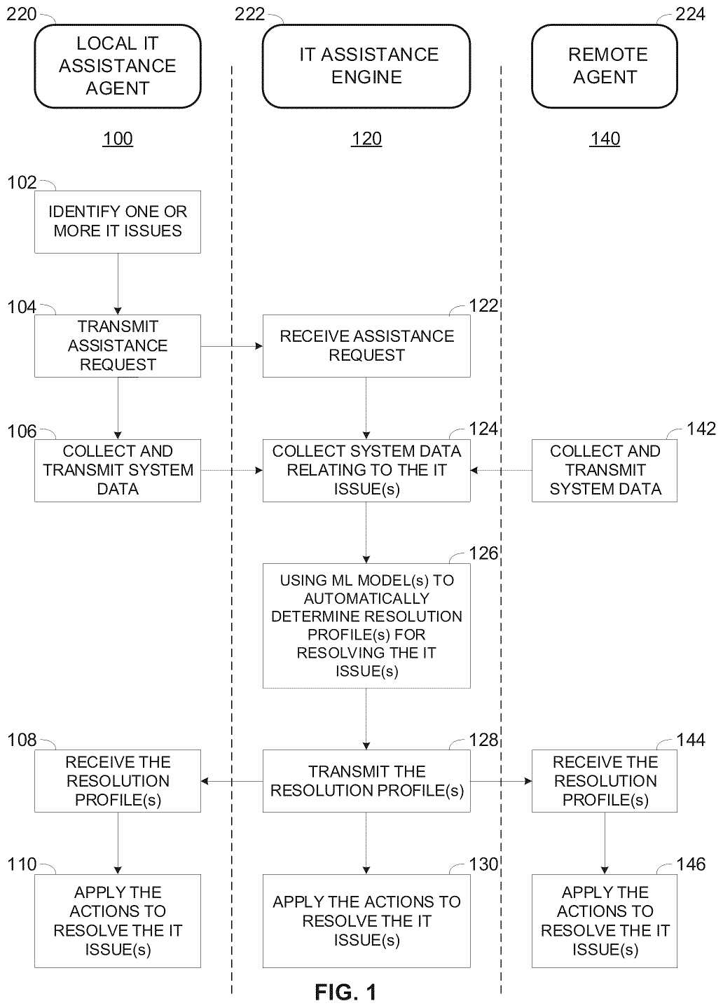

Referring now to the drawings, FIG. 1 is a flowchart of an example process of automatically resolving IT issues using machine learning models.

An example, processes 100 may be executed by a local IT assistance agent executed by one or more client devices to resolve one or more IT issues related to the respective client device.

In particular, the local IT assistance agent may cooperate with a remote IT assistance engine executed by one or more remote systems, servers, and/or services executing an example process 120 to resolve IT issues related to the client devices using AI (such as, using one or more ML models).

The local IT assistance agent of a respective client device may issue one or more assistance requests to report one or more IT issues related to the respective client device. One or more IT issues may relate, for example, to one or more functional components of the respective client device. In another example, one or more IT issues may relate to one or more services and/or infrastructures serving the respective client device.

In response to an assistance request received from the local IT assistance agent of a respective client device, the IT assistance engine may collect system data related to the reported IT issue(s). System data may be collected, for example, from the respective client device, from one or more systems, platforms, and/or services serving the respective client device, and/or the like.

The IT assistance engine may apply one or more ML models to the collected data to determine automatically one or more solutions estimated to resolve the IT issue(s). The IT assistance engine may further compute a set of actions and/or instructions implementing the solution(s) and transmit the set to one or more agents adopted to automatically execute the set of actions in attempt to resolve the IT issue(s).

The agents adapted to receive and execute the set of actions for resolving the IT issue(s) may include, for example, the local IT assistance agent executed by the respective client device. In another example, one or more other agents, for example, agents deployed at one or more of the systems, platforms, and/or services serving the respective client device may be adapted to execute an example process 140 for receiving and automatically executing the set of actions for resolving the IT issue(s).

In various embodiments, the system executes several analysis and resolution stages:
Request: The system receives a prompt/request (such as a ticket) about an IT issue.
Request Analysis: The system analyzes the request to understand the IT issue and the data relevant to the request.
Data Collection: The system collects the raw data according to the analysis.
Data Analysis: The system analyzes the raw data received to obtain insights relevant to the IT issue.
IT issue identification: The system checks that the cause for the IT issue was correctly identified in the analysis. If the system cannot identify the cause for the IT issue, then the system obtains additional raw data according to an alternative resolution profile.
Resolution Profile: The system determines the resolution profile most suitable for the cause identified above from a variety of relevant resolution profiles.

As an example, the system receives a request from a user indicating that they are experiencing slow internet speed. The system analyzes the request and understands (for example, via LLM and NLP analysis of the ticket text) that the problem relates to internet speed and decides to conduct a speed test. The system obtains the speed test results and determines that the speed is slow (for example, by determining that the speed does not meet an expected speed metric). The system determines the root cause of the issue, (in this case, the internet connection is slow), and the system executes a resolution profile that renews the connection and/or IP address.

As another example, the system receives a request from a user indicating that they are experiencing slow internet speed. The system analyzes the request and understands (for example, via LLM and NLP analysis of the ticket text) that the problem relates to internet speed and decides to conduct a speed test. The system obtains the speed test results and determines that the speed is normal. The system determines that the internet connection is not the cause for the slow internet and searches for another possible cause by collecting additional system data including running processes and CPU and memory metrics. Next, the system determines that there is one process consuming a lot of CPU and memory. The system determines that the cause for the IT issue is the memory-consuming process. The system executes (or recommends) a resolution profile that shuts down the memory-consuming process.

### Schematic Illustrations

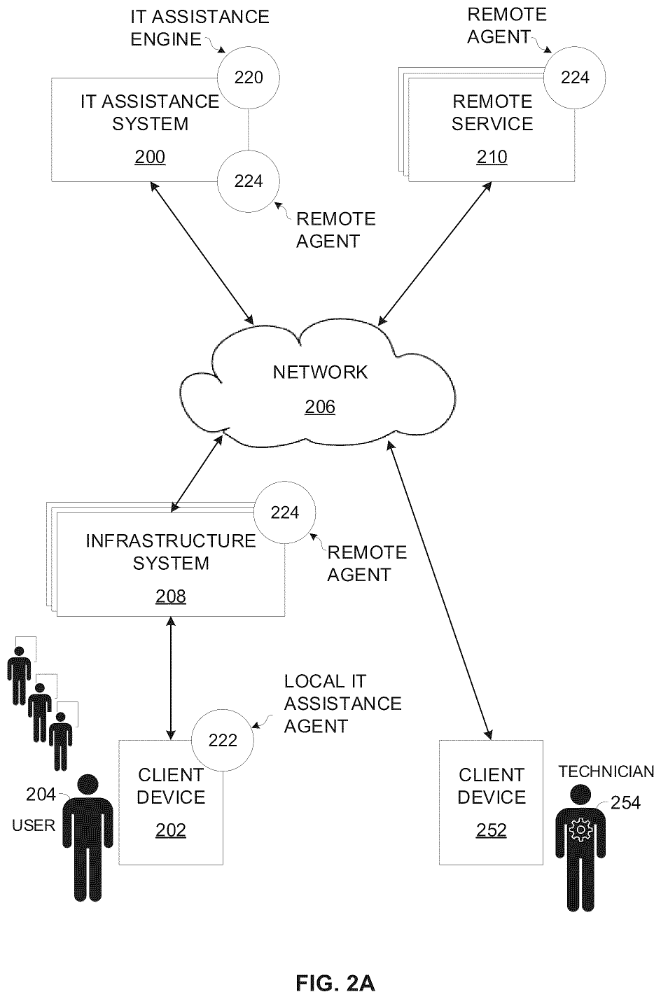

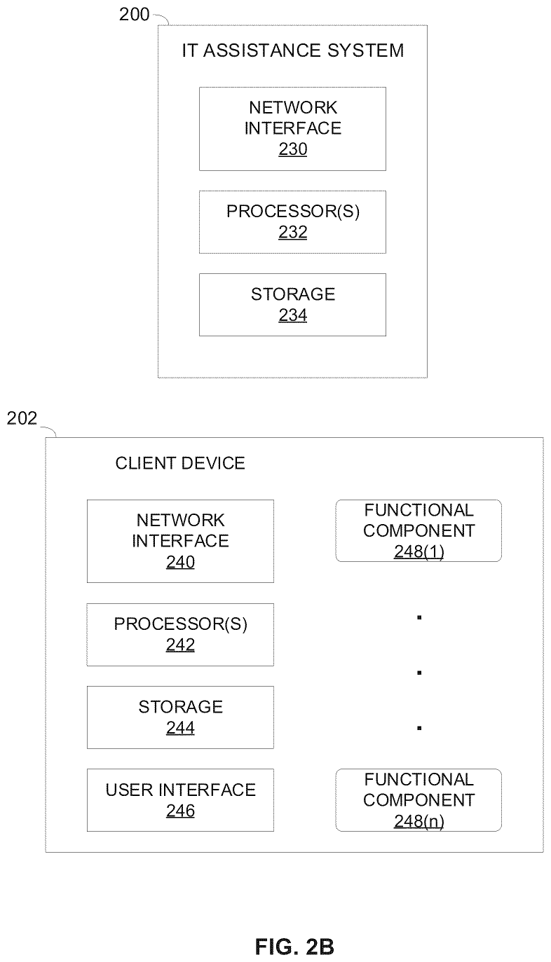

Reference is also made to FIG. 2A and FIG. 2B, which are schematic illustrations of an example system for automatically resolving IT issues using machine learning models.

As seen in FIG. 2A, an example IT assistance system 200 may be adapted to support one or more client devices (remote machines) 202, for example, a desktop, a laptop, a server, a smartphone, a tablet, a smart watch, a proprietary client device and/or the like for resolving IT issues related to the client devices 202.

The client devices 202 may be typically associated with users 204 using, operating, and/or otherwise engaged with the client devices 202. However, one or more of the client devices 202 may be adapted to operate with no human intervention, for example, a server, a network equipment unit (for example, gateway, router, switch, etc.), a security system and/or service (for example, firewall service, IT system, etc.), and/or the like.

The client devices 202 may have network connectivity for connecting to one or more networks, network 206, comprising one or more wired and/or wireless networks, for example, a Local Area Network (LAN), a Wireless LAN (WLAN, for example, Wi-Fi), a Wide Area Network (WAN), a Metropolitan Area Network (MAN), a cellular network, the internet and/or the like.

Optionally, one or more of the client devices 202 may connect to the network 206 via one or more infrastructure systems 208, for example, a network equipment system, unit, and/or service such as, for example, a gateway, a router, a switch, and/or the like, a security system and/or service such as, for example, a firewall, an access control unit and/or service, and/or the like.

The client devices 202 may communicate with the IT assistance system 200 over the network 206 to report IT issues they may encounter and optionally receive from the IT assistance system 200 instructions to automatically resolve these IT issues.

One or more of the client devices 202 may communicate via the network 206 with one or more remote services 210, for example, a mail service, an organization account, a database, a Virtual Private Network (VPN) service, a Customer Relations Management (CRM) system, a subscription account (for example, video conferencing, social media, financial service, etc.), and/or the like.

As seen in FIG. 2B, the IT assistance system 200 (for example, a server, a processing node, a cluster of processing nodes, and/or the like) may comprise a network interface 230 for connecting to the network 206, a processor(s) 232 for executing the process 120, and a storage 234 for storing data and/or code (program store).

The network interface 230 may include one or more wired and/or wireless network interfaces, ports, and/or links, implemented by hardware, software, firmware, and/or a combination thereof for connecting to the network 206.

The processor(s) 232, homogeneous or heterogeneous, may include one or more processing nodes and/or cores optionally arranged for parallel processing, as clusters and/or as one or more multi core processor(s).

The storage 234 may include one or more non-transitory persistent storage devices, for example, a ROM, a Flash array, a Solid State Drive (SSD), a hard drive (HDD), and/or the like. The storage 234 may also include one or more volatile devices, for example, a RAM component, a cache, and/or the like. Optionally, the storage 234 may further comprise one or more network storage devices, for example, a storage server, a Network Accessible Storage (NAS), a network drive, a database server and/or the like accessible through the network interface 230.

The processor(s) 232 may execute one or more software modules such as a process, a script, an application, a (device) driver, an agent, a utility, a tool, an Operating System (OS), a plug-in, an add-on, and/or the like each comprising a plurality of program instructions stored in a non-transitory medium (program store) such as the storage 234 and executed by one or more processors such as the processor(s) 232.

The processor(s) 232 may optionally integrate, utilize and/or facilitate one or more hardware elements (modules) integrated and/or utilized in the IT assistance system 200, for example, a circuit, a component, an Integrated Circuit (IC), an Application Specific Integrated Circuit (ASIC), a Field Programmable Gate Array (FPGA), a Digital Signals Processor (DSP), a Graphic Processing Unit (GPU), an Artificial Intelligence (AI) accelerator and/or the like.

The processor(s) 232 may therefore execute one or more functional modules implemented using one or more software modules, one or more of the hardware modules and/or combination thereof.

For example, the processor(s) 232 may execute an IT assistance engine 220 for executing the process 120 for automatically determining solutions for resolving IT issues related to one or more of the client devices 202. In another example, the processor(s) 232 may execute one or more ML models to support the IT assistance engine 220, for example, a Neural Network (NN), a classifier, a statistical a classifier, a Support Vector Machine (SVM), and/or the like adapted to automatically determine one or more solutions for resolving each of a plurality of IT issues related to one or more of the client devices 202.

Optionally, the IT assistance system 200, specifically the processor(s) 232, may execute one or more agents 224, designated remote agents, to support resolution of one or more IT issues related to one or more of the client devices 202, for example, collect system data related to the IT issues, executing actions for resolving the IT issues, and/or the like as describe herein after in detail. Optionally, the remote agent 224 executed by the IT assistance system 200 may be integrated with the IT assistance engine 220 such that they may be deployed, launched and/or executed as a single package.

It should be noted, that each of functional modules executed by the processor(s) 232, for example, the IT assistance engine 220, the remote agent 224, and/or the like may be executed by the processor(s) 232 such that any one or more processors of the processor(s) 232 may execute one or more of the functional modules and/or part thereof or optionally not participate in execution of any of the functional modules.

Optionally, the IT assistance system 200 may be utilized by one or more cloud computing services, platforms and/or infrastructures such as, for example, Infrastructure as a Service (IaaS), Platform as a Service (PaaS), Software as a Service (SaaS) and/or the like provided by one or more vendors, for example, Google Cloud, Microsoft Azure, Amazon Web Service (AWS) and Elastic Compute Cloud (EC2), IBM Cloud, and/or the like that may communicate with the client devices 202 via the network 206 for resolving one or more IT issues related to one or more of the client devices 202.

Optionally, one or more of the remote services 210 and/or one or more of the infrastructure systems 208 may also execute one or more remote agents 224 for executing the process 140 to support resolution of one or more IT issues related to one or more of the client devices 202, for example, collect system data related to one or more IT issues, execute actions for resolving the one or more IT issues, and/or the like.

The remote agents 224 may be designed, implemented, and/or deployed to support resolution of one or more IT issues using one or more integration, migration, and/or development methods, techniques, and/or means. For example, one or more remote agents 224 may be implemented, and/or deployed using one or more plug-in modules, add-on packages, and/or the like comprising the IT issues resolution functionality. In another example, one or more remote agents 224 may be designed using one or more Software Development Kits (SDK) comprising the IT issues resolution functionality.

Each client device 202 may include a network interface 240 such as the network interface 230 for connecting to the network 206, a processor(s) 242 such as the processor(s) 232 for executing the process 100, and a storage 244 such as the storage 234 for storing data and/or code (program store).

One or more of the client devices 202, specifically client devices 202 which may be associated and operated by respective users 204 may further comprise a user interface 246 comprising one or more user interfaces, such as Human Machine Interfaces (HMI) for interacting with the user 204. For example, HMIs include a keyboard, a mouse, a touchscreen, a touchpad, a pointing device, a display, a speaker, an earphone, a microphone, a tactile interface such as fingerprint reader, etc., and/or the like.

As described for the network interface 230, the network interface 240 may include one or more wired and/or wireless network interfaces, ports, and/or links, implemented by hardware, software, firmware, and/or a combination thereof for connecting to the network 206.

Also, similarly to the processor(s) 232, the processor(s) 242, homogenous or heterogeneous, may include one or more processing nodes and/or cores optionally arranged for parallel processing, as clusters and/or as one or more multi core processor(s). The storage 244 may include one or more non-volatile components, such as, for example, a ROM, a Flash array, an SSD, and/or the like and/or one or more volatile components such as, for example, a RAM device, a cache component, and/or the like.

The processor(s) 242 may execute one or more software modules each comprising a plurality of program instructions stored in a non-transitory medium (program store) such as the storage 234 and executed by one or more processors such as the processor(s) 232. Optionally, the processor(s) 242 of one or more of the client devices 202 may integrate, utilize and/or facilitate one or more hardware elements (modules) integrated and/or utilized in the respective client device 202, for example, a circuit, a component, an IC, an ASIC, an FPGA, a DSP, a GPU, an AI accelerator and/or the like.

The processor(s) 242 may therefore execute one or more functional modules implemented using one or more software modules, one or more of the hardware modules and/or combination thereof. For example, the processor(s) 242 of each client device 202 may execute local IT assistance agent 222 for executing the process 100 for resolving IT issues related to the respective client device 202.

The local IT assistance agent 222 may be implemented at each of the client device using one or more architectures, designs, and/or deployments.

For example, the local IT assistance agent 222 executed by one or more of the client devices 202 may comprise a standalone local application executed by the respective client device 202, specifically by the processor(s) 242 of the respective client device 202. In another example, the local IT assistance agent 222 executed by one or more of the client devices 202 may be implemented by web application, hosted by one or more remote resources, for example, at the IT assistance system 200, which may be loaded and executed by the processor(s) 242 of the respective client device 202. In another example, the local IT assistance agent 222 executed by one or more of the client devices 202 may comprise a web browser (for example, Chrome, Edge, Firefox, etc.) adapted to load and render one or more webpages hosted by one or more remote resources, for example, at the IT assistance system 200 which implement the logic of the local IT assistance agent 222.

The local IT assistance agent 222 may comprise and/or expose a user interface for interacting with the user 204, for example, a visual interface such as, for example, a Graphic User Interface (GUI), an audio input and/or playback interface, a tactile interface, and/or the like which may be presented and utilized via the user interface 246 of the client device 202. Moreover, one or more of the user interfaces, for example, the GUI may be implemented as a local GUI, a web-based GUI, and/or a combination thereof according to the architecture, and/or deployment of the local IT assistance agent 222.

Each of functional modules executed by the processor(s) 242 of each client device 202, for example, the local IT assistance agent 222 and/or the like may be executed by the processor(s) 242 of the respective client device 202 such that any one or more processors of the processor(s) 242 may execute one or more of the functional modules and/or part thereof or optionally not participate in execution of any of the functional modules.

Each client device 202 may comprise one or more one or more functional components 248, for example, N functional components 248(1) to 248(n) utilized by hardware, software, firmware, and/or a combination thereof to provide the functionality of the respective client device. The functional components 248 may obviously include the network interface 240, the processor(s) 242, and the storage 244.

The functional components 248 may include, for example, one or more hardware components, for example, a network device, a memory device, a processing circuit, a communication cable, and/or the like. In another example, the functional components 248 may include one or more software components (modules) executed by the processor(s) 242 and/or one or more other functional components 248 of the client device 202, for example, an Android OS, a communication application (for example, communication stack, etc.), a remote access agent (for example, web browser, VPN agent, web application, a local CRM agent, etc.), a control application (for example, IoT management tool, an infrastructure monitor and control agent, etc.), and/or the like. In another example, the functional components 248 may include a combination of one or more hardware components and one or more software components.

Optionally, one or more technicians 254, for example, an IT person, an IT expert, an administrator, and/or the like may use one or more client devices 252 such as the client device 202 for connecting to the network 206 and interact with the IT assistance engine 220. Optionally, one or more technicians 254 using their client devices 252 may further access one or more client devices 202, one or more of the remote services 210, and/or one or more infrastructure systems 208.

For brevity, the processes 100, 120, and 140 are described for resolving IT issues related to a single client device 202. This, however, should not be construed as limiting since, as may be apparent to a person skilled in the art, the process 100 may be executed by a plurality of client devices 202 and the process 120, and optionally the process 140, may duplicated, expanded, and/or scaled for resolving IT issues related to the plurality of client devices 202.

As shown at 102, the process 100 executed by the local IT assistance agent 222 of a client device 202 starts with the local IT assistance agent 222 identifying one or more IT issues related to the client device 202.

The IT issues may relate to one or more failures and/or problems encountered in relation to the client device 202 and/or its associated user 204. In particular, IT issues may relate to one or more of the functional components 248 of the client device 202, to one or more software applications executed by the client device 202, one or more services accessed by the client device 202, one or more accounts related to the client device 202, and/or the like. Moreover, since at least some of the IT issues may relate to interaction and communication between the client device 202 and one or more remote services 210, the IT issues may relate to one or more of the infrastructure systems 208.

For example, a certain IT issue may relate to inability of a user 204 associated with the client device to log into and/or access his account using his credentials, whether an account at a remote service 210 (for example, mail service, remote desktop, cloud service, etc.), and/or a local account of an application and/or service executed locally by the client device 202 (for example, secure service, encrypted document, etc.). In another example, a certain IT issue may relate to inability of the client device 202 to access the network206, and/or a certain remote service 210. In another example, a certain IT issue may relate to a failure to invoke one or more applications, agents, and/or the like, for example, a VPN client, a text editing application, a simulation model, and/or the like.

However, the IT issues may not be limited to problems, and/or failures related to the client device 202. Rather, the IT issues may further include one or more requests to add, include, expand, remove and/or otherwise manipulate capabilities, functionality, and/or features of the client device 202 and/or for making them available to the associated user 204. For example, a certain IT issue may relate to a request to add the associated user 204 to a certain admin group. In another example, a certain IT issue may relate to installing and configuring a VPN agent on the client device 202. In another example, a certain IT issue may relate to a request to create a new account for the user 204 at one or more remote services 210, change credentials for one or more accounts, and/or the like. The IT issues may be identified by the local IT assistance agent 222 using one or more methods, techniques, and/or algorithms.

For example, the user 204 may interact with the local IT assistance agent 222 to report one or more IT issues. To this end, the user 204 may interact with the local IT assistance agent 222 via one or more of the HMI interfaces, for example, the GUI, and/or the like of the user interface 246. In another example, one or more functional components 248, for example, an application, an agent, a device driver, and/or the like may report a failure to the local IT assistance agent 222, for example, via one or more system calls, OS routines, Application Programming Interface (API) functions, and/or the like. In another example, the local IT assistance agent 222 may continuously, and/or periodically monitor one or more of the functional components 248, one or more of the remote services 210, and/or one or more of the infrastructure systems 208 to detect one or more IT issues. For example, the local IT assistance agent 222 may issue one or more system calls, API calls, and/or the like to probe one or more of the functional components 248 and determine their functional and/or operational state accordingly. In another example, the local IT assistance agent 222 may transmit one or more messages, requests, and/or signals to one or more of the services 210, and/or infrastructure systems 208 to evaluate their availability, connectivity, functionality, and/or the like and determine their functional and/or operational state accordingly.

As shown at 104, the local IT assistance agent 222 may transmit to the IT assistance system 200, specifically to the IT assistance engine 220 an assistance request, via the network 206, for example, a message, a packet, an alert, and/or the like to report the identified IT issue(s) and request support to resolve the IT issue(s). As shown at 122, the IT assistance engine 220 may receive the assistance request transmitted from the client device 202 by the local IT assistance agent 222.

As shown at step 124, in response to receiving the assistance request, the IT assistance engine 220 may collect system data related to the IT issue(s) reported in the assistance request.

The system data may include, for example, informative data collected by the local IT assistance agent 222 as shown at 106 and transmitted to the IT assistance engine 220. The informative data collected by the local IT assistance agent 222 may comprise, for example, one or more operational parameters related to one or more of the plurality of functional components 248 of the client device 202, for example, a hardware component, a software component, and/or a combination thereof. For example, the informative data collected by the local IT assistance agent 222 may include one or more operational parameters, status data, and/or settings of one or more functional components, for example, a network adapter, a processing device, a network port, an application, a communication protocol, and/or the like.

In another example, the informative data collected by the local IT assistance agent 222 may comprise one or more operational parameters, status data, credentials, settings and/or the like of one or more accounts (for example, user account at remote system, etc.), and/or services (for example, mail server, etc.) accessed by the client device 202. In another example, the system data may include informative data, specifically service data collected from one or more of the remote services 210 (for example, mail server, CRM system, online financial service, etc.), one or more of the infrastructure systems 208 (for example, router, gateway, etc.), and/or the like. Such informative data may include, for example, one or more operational parameters, status data, and/or settings related to the one or more of the remote services 210, and/or infrastructure systems 208. For example, informative data related to a certain remote service 210, for example, a mail server, may comprise, for example, availability, responsiveness, access latency, access port settings, and/or the like. In another example, informative data related to a certain infrastructure system 208, for example, a gateway, may comprise, for example, one or more network parameters defined at the router, for example, domain, address ranges, protocol support, and/or the like.

This informative data related to the remote services 210 and/or infrastructure systems 208 may be collected, for example, as shown at 142, by one or more of the remote agents 224 deployed and executed by one or more of the remote services 210 and/or infrastructure systems 208 and transmitted by the remote agents 224 to the IT assistance engine 220 over the network 206. In another example, the IT assistance engine 220 may access one or more of the remote services 210 and/or infrastructure systems 208 to directly retrieve at least some informative data related to one or more of the remote services 210, and/or infrastructure systems 208.

Moreover, at least part of the system data may be derived one or more tests conducted to system tests, checks, and/or probes (health checks) to collect at least some of the system data, for example, informative data. such tests, may include, for example, functional tests of one or more of the functional components which may relate to the reported IT issue(s), for example, a functional component 248, one or more of the remote services 210, one or more of the infrastructure systems 208, and/or the like. One or more of the tests conducted to collect, retrieve, and/or derive system data may be conducted automatically by directly communicating, for example, by the IT assistance engine 220 and/or the local IT assistance agent 222, with one or more hardware and/or software components of the tested resources. However, one or more tests may include interaction with the user 204 such that the user 204 may be instructed, for example, by the local IT assistance agent 222, via the user interface 246, to perform one or more actions and/or operations to support execution of one or more test procedures to collect, derive, and/or identify system data which may be useful, and/or relevant in relation to the reported IT issue(s). Such system data may include, for example, informative data derived from the tests, user input provided by the user 204 in response to instructions, a combination thereof, and/or the like.

The IT assistance engine 220 may therefore initiate, and/or instruct initiation of one or more one or more system tests to collect at least some of the system data, for example, informative data related to the IT issue(s). For example, assuming the reported IT issue(s) relate to a network connectivity problem. In such case, the IT assistance engine 220 may initiate one or more tests, for example, hardware test procedures on one or more network controllers of the client device 202 to collect informative data related to the network hardware. In another example, the IT assistance engine 220 may initiate one or more software and/or protocol level tests, for example, “ping,” “open socket,” and/or the like in order to collect informative data related to connectivity status of the client device 202.

In another example, the system data user may comprise user behavior data collected by the local IT assistance agent 222, specifically user behavior data which may relate to the reported IT issue(s). The user behavior data may capture, record and/or log interaction of the associated user(s) 204 with the client device 202 and/or content rendered by the client device 202. For example, the user behavior data may include interaction of the user 204 with the HMI of the user interface 246, accessed resources (for example, screens, web pages, applications, menus, etc.), selected items (for example, clicked and/or pointed icons, links, menu items, etc.), and/or the like. For example, assuming a user 204 interacts with his client device 202 to engage, use, and/or operate one or more applications, for example, an electronic mail application, an electrical design tool, a software programming suite, and/or the like, the user behavior data collected by the local IT assistance agent 222 may comprise interaction of the user 204 with the applications via the user interface 246, for example, mouse movement, keyboard strokes, sound commands, and/or the like. The user behavior data may further include timing data, for example, speed of interaction operations (mouse, keyboard, etc.), time gaps between interactions, and/or the like. The user behavior data may further log the interaction of the associated user(s) 204 over time and may arrange the interactions in an order according to their occurrence timing, sequence, and/or the like.

In another example, the system data user may comprise user input related to the reported IT issues which is provided by one or more users 204 of the client device 202. The user input may be collected, for example, by the local IT assistance agent 222 and transmitted to the IT assistance engine 220 via the network 206. Optionally, in deployments in which the local IT assistance agent 222 is implemented by a web application, web-based GUI, and/or a webpage executed by the IT assistance engine 220 and rendered by the local IT assistance agent 222, the IT assistance engine 220 may collect the user input provided by the user 204.

Optionally, the IT assistance engine 220 and/or the local IT assistance agent 222 may be adapted to invoke one or more chat interfaces, for example, GUI based chat bot, an audio-based chat bot, and/or the like for interacting with the user 204 of the client device 202 to receive the user input.

The user input may include, for example, a description of an IT issue identified and/or encountered by the user 204 using the client device 202. In another example, the user input may include one or more contextual details related to an IT issue identified and/or encountered by the user 204, for example, an operation mode of one or more functional components 248, one or more attributes of the execution environment of the client device 202, for example, suspicious effects, phenomena, and/or signs, an execution goal and/or target of one or more of the functional components 248, an execution load on the client device 202, and/or the like.

The IT assistance engine 220 may apply Natural Language Processing (NLP) for interpreting the user input. For example, the IT assistance engine 220 may apply one or more NLP algorithms to analyze the user input and/or part thereof in order to identify the use input.

Optionally, the user input may be provided by the user 204 in response to one or more queries, and/or questions presented to him via the user interface 246, for example, by the local IT assistance agent 222, and/or the IT assistance engine 220. For example, the IT assistance engine 220 may generate one or more guiding questions according to the reported IT issue(s) which may be presented to the user 204 by the local IT assistance agent 222 via the user interface 246.

The system data collected by the IT assistance engine 220, for example, a scope of data, a type of data, data details, and/or the like in relation to one or more IT issues may be predefined, for example, by one or more technicians such as the technicians 254. In another example, the system data collected by the IT assistance engine 220 in relation to one or more IT issues may be defined based on knowledge, and/or experience formed based on past IT issues resolution conducted, either by the IT assistance engine 220, by one or more technicians 254, using another IT tool, and/or the like.

Optionally, the system data (type, scope, parameters, etc.) collected by the IT assistance engine 220 in relation to one or more IT issues and/or part thereof may be learned over time and/or predicted using one or more ML models adapted and/or trained to identify system data patterns related to one or more of the IT issues and learn which system data may be relevant for deriving possible solutions to resolve the respective IT issues. Such ML models are described in further detail herein after in step 126. In such case, at least part of the system data collected by the IT assistance engine 220 may be indicated, instructed, and/or otherwise identified by one or more of the trained ML models. For example, assuming the reported IT issue(s) relate to an inability to access a certain shared drive and/or folder. In such case, the IT assistance engine 220 may collect system data, for example, informative data defined, identified, and/or instructed by one or more of the ML model(s) which are trained to learn which system data may be relevant, useful, and/or beneficial to determine a root cause of the access issue and for determine possible solutions for resolving the access issue.

Moreover, the IT assistance engine 220 may initiate, conduct, and/or launch one or more system checks, tests, and/or probes (health checks) defined, indicated, and/or suggested by one or more of the ML model(s) which may be further adapted and/or trained to determine which tests may produce system data that may be relevant for deriving possible solutions to resolve one or more IT issues. For example, assuming the reported IT issue(s) relate to a failure of an application executed by the client device 202 to retrieve data from a remote network resource, for example, a database. In such cases, the IT assistance engine 220 may conduct one or more tests (health checks) indicated, defined, and/or instructed by one or more of the ML model(s) which estimate these tests may produce system data, for example, informative data which may be relevant, useful, and/or beneficial for determining the root cause of the data retrieval issue and for determine possible solutions for resolving the access issue. For example, the ML model(s) may determine and/or estimate, based on learned data patterns related to IT issues, that an access privileges test and/or inquiry conducted for testing the credentials used by the client device 202 to access the database and their access rights may yield system data useful for determining possible root cause problem of the access issue. The IT assistance engine 220 may therefore initiate the access privileges test and/or inquiry according to an indication and/or suggestion received from the ML model(s).

As shown at step 126, the IT assistance engine 220 may automatically determine one or more resolution profiles using one or more ML models applied to analyze the collected system data. Each resolution profile may comprise a set of actions implementing one or more solutions for resolving the reported IT issue(s).

In various embodiments, the IT assistance engine 220 may inject the system data into one or more ML models, for example, a neural network, a classifier, an SVM, and/or the like which are adapted to learn a plurality of system data patterns typical to IT issues related to the client devices 202.

The ML model(s) may be further adapted to predict, and/or estimate one or more solutions for resolving the IT issues and generate one or more resolution profiles accordingly which include a set of actions implementing the solution estimated to resolve the IT issues.

In various embodiments, the ML model(s) are applied to a plurality of system data sets collected in relation to a plurality of IT issues to estimate, and/or predict a root cause of one or more IT issues characterized by a respective system data (in other words, IT issues reflected by the respective system data or that induce the creation of the respective system data set). The ML model(s) may be further adapted to generate accordingly one or more resolution profiles implementing one or more solutions predicted to resolve the estimated root cause and thus resolve the IT issue(s).

In particular, the ML model(s) may be applied to feature vectors each comprising a plurality of features extracted from a respective one of the system datasets by one or more feature extraction engines, interchangeably designated feature extractor. The feature extractor may be utilized, for example, as one or more independent ML models, for example neural networks, and/or integrated as one or more layers in one or more neural networks facilitating the ML model(s) themselves.

As such, the ML model(s) applied to the system data collected in relation to the IT issue(s) reported by the local IT assistance agent 222 may be used to determine automatically one or more resolution profiles implementing one or more solutions estimated to resolve the reported IT issue(s). Specifically, the ML model(s) may be applied to a feature vector comprising a plurality of features extracted by the feature extractor from the system data collected in relation to the reported IT issue(s). In deployments where the feature extractor is integrated and/or utilized by the ML model(s), the collected system data may be directly injected to the ML model(s).

The ML model(s) may be trained in one or more supervised, unsupervised, and/or semi-supervised training sessions using one or more training datasets comprising a plurality of training samples. The training samples may comprise, for example, annotated (labeled) training samples for supervised training, unlabeled training samples for unsupervised training, and/or a combination of labeled and unlabeled training samples for semi-supervised training.

Each of the training samples may comprise a respective system dataset, optionally associated with one or more IT issues having a root cause characterized by the respective system dataset.

Moreover, at least some of the training samples, for example, the labeled training samples may associate one or more of a plurality of resolution profiles with each of a plurality of IT issues related to client devices such as the client devices 202. Trained with such training samples, the ML model(s) may therefore, adapt, adjust, and/or evolve to learn which of the resolution profiles may be applied for resolving each of the IT issues.

For example, one or more of the resolution profiles may be associated with one or more IT issues based on past experience during which solutions and actions applied and executed for resolving IT issues were recorded. Each of the resolution profiles, specifically the set of actions of the respective resolution profile, previously recorded to successfully resolve one or more of the IT issues may be thus associated with the respective IT issue(s) and used for training the ML model(s).

In another example, one or more of the resolution profiles associated with one or more of the plurality of IT issues may comprise a respective set of actions defined by one or more technicians, for example, an IT person, an expert, an administrator, and/or the like for resolving the respective IT issues. For example, the set of actions of one or more of the resolution profiles may be derived from recordation of the actions applied by one or more technicians to resolve one or more IT issues in the past. In another example, the set of actions of one or more of the resolution profiles may be estimated by one or more technicians to resolve one or more IT issues.

The ML model(s) may be adapted to automatically determine and/or select one or more resolution profiles comprising sets of actions, optionally utilized by scripts, retrieved from one or more resolution repositories, for example, a database, and/or the like. Optionally, the ML model(s) may be adapted to determine and/or select one or more resolution profiles for one or more IT issue(s) based on an account associated with the client device 202, for example, an account of the user 204, an account assigned to the client device 202, an account of an organization with which the client device 202 and/rot the user 2-04 are associated. Each account may be associated with one or more respective resolution profiles each comprising a set of actions estimated to resolve the reported IT issue(s).

Optionally, the ML model(s) may include one or more generative ML models adapted to automatically define the set of actions of one or more resolution profiles estimated, predicted and/or selected for resolving the IT issue(s) reported by the local IT assistance agent 222.

The generative ML model(s) may be pre-trained and adapted to generate one or more resolution profiles which are not duplicates of previous resolution profiles applied in the past and/or estimated by technicians to resolve one or more IT issues. Rather, the generative ML model(s) may estimate, predict, infer, and/or derive, based on past knowledge and data, one or more sets of actions implementing one or more solutions estimated to resolve one or more IT issues and may generate one or more resolution profiles accordingly.

According to embodiments, the ML model(s) used by the IT assistance engine 220, may include one or more online AI services, for example, ChatGPT, Bard, Gemini, and/or the like employing one or more pre-trained generative ML models, infrastructures and/or architectures adapted to for respond and provide answers to natural language queries also known as prompts.

The IT assistance engine 220 communicating with the online generative ML model(s), for example, via the network 206 and using their API, may inject to the online generative ML model(s) one or more prompts (queries) comprising the system data collected in relation to the IT issue(s) reported by the local IT assistance agent 222. In response, the online generative ML model(s) may estimate a root cause of the IT issue(s) and may generate one or more resolution profiles comprising one or more sets of actions implementing one or more solutions estimated, and/or predict to resolve the IT issue(s).

As shown at 128, the IT assistance engine 220 may transmit one or more of the resolution profile(s) generated, inferred, and/or determined by the ML model(s) to one or more agents adapted to execute automatically the set of actions of the resolution profile(s) to resolve automatically the IT issue(s) related to the client device 202.

For example, as shown at 108, the IT assistance engine 220 may transmit one or more of the resolution profile(s) to the local IT assistance agent 222 executed by the client device 202. As shown at step 110, the local IT assistance agent 222 may apply the set of actions of the received resolution profile(s) to resolve the IT issue(s).

For example, assuming the IT issue related to the client device 202 is a network connectivity problem estimated, by the ML model(s) based on the system data, to originate from a failure, and/or a problem in a network interface of client device 202. Further assuming, a certain resolution profile, determined using the ML model(s), comprises a set of actions for reconfiguring, resetting, updating the network interface and/or the like. In such case, the IT assistance engine 220 may transmit the certain resolution profile to the local IT assistance agent 222 which may execute the set of actions at the client device 202 to resolve the network connectivity problem.

Optionally, the set of actions of one or more of the resolution profile(s) may include instructions for the user 204 of the client device 202 to take one or more actions. For example, assuming the IT issue related to the client device 202 is a network connectivity problem estimated, by the ML model(s) based on the system data, to originate from a fatal failure in a network interface connecting the client device 202 to the network 206 via a network cable. Further assuming, a certain resolution profile, determined using the ML model(s), comprises a set of actions for connecting the network cable to another (different) network interface of the client device 202. In such case, the set of actions of the certain resolution profile may comprise instructions to the user 204 to disconnect the network cable from the currently connected network interface and connect the cable to the other network interface.

In another example, as shown at step 144, the IT assistance engine 220 may transmit one or more of the resolution profile(s) to one or more of the remote agents 224 executed by one or more of the infrastructure systems 208 which may apply the set of actions of the received resolution profile(s), as shown at step 146, to resolve the IT issue(s).

For example, assuming the IT issue related to the client device 202 is a network connectivity problem estimated, by the ML model(s) based on the system data, to originate from a problem, and/or misconfiguration of a certain infrastructure system 208, for example, a gateway connecting the client device 202 to the network 206. Further assuming, a certain resolution profile, determined using the ML model(s), comprises a set of actions for reconfiguring, resetting, and/or updating the gateway. In such case, the IT assistance engine 220 may transmit the certain resolution profile to a remote agent 224 executed by the router which may execute the set of actions at the gateway to resolve the network connectivity problem of the client device 202.

In another example, as also shown at 142 and 146, the IT assistance engine 220 may transmit one or more of the resolution profile(s) to one or more of the remote agents 224 executed by one or more of the remote services 210 which may apply the set of actions of the received resolution profile(s) to resolve the IT issue(s).

For example, assuming the IT issue related to the client device 202 is an access problem to a certain remote service 210, for example, a restricted access database, estimated, by the ML model(s) based on the system data, to originate from a failure to update credentials of the user 204 of the client device 202 at the restricted access database. Further assuming, a certain resolution profile, determined using the ML model(s), comprises a set of actions for querying a certain access control database and/or record whether the user 204 is authorized for access to the restricted access database and in case he is authorized, update an access control module of the restricted access database to include the credentials of the user 204. In such case, the IT assistance engine 220 may transmit the certain resolution profile, for example, to a remote agent 224 executed by the restricted access database which may execute the set of actions to resolve the access issue for the user 204 using the client device 202.

In another example, as shown at step 130, the IT assistance engine 220 may transmit the certain resolution profile to the remote agent 224 executed by the IT assistance system 200 itself, optionally by the IT assistance engine 220 having access to the remote service and/or infrastructure from which the IT issue is estimated to originate. For example, in case of the access failure issue estimate to originate from the access control database/record and to the access control module, assuming the IT assistance engine 220 has access and manipulation write, adjust, etc. privileges over these modules, the IT assistance engine 220 may execute the set of actions to resolve the access issue for the user 204 using the client device 202.

In another example, the IT assistance engine 220 may transmit multiple resolution profiles to multiple agents, for example, the local IT assistance agent 222 and one or more remote agents 224, a plurality of remote agents 224, and/or the like. Each of the agents may automatically execute the set of actions of its respective resolution profile such that the agents may jointly resolve the IT issue(s) related to the client device 202.

For example, assuming the IT issue related to the client device 202 is a network connectivity problem estimated, by the ML model(s) based on the system data, to originate from a port misconfiguration at the client device 202 and a certain infrastructure system 208, for example, a gateway connecting the client device 202 to the network 206. Further assuming, a solution, determined using the ML model(s), comprises reconfiguring the port number at the client device 202 and at the gateway to be same port. In such case, the IT assistance engine 220 may transmit a first resolution profile comprising a set of actions for reconfiguring the port number at the client device 202 to the local IT assistance agent 222 and a second resolution profile comprising a set of actions for reconfiguring the port number at the gateway to a remote agent 224 executed by the gateway. The local IT assistance agent 222 and the remote agent 224 may each execute the set of actions of their respective resolution profiles to jointly resolve the network connectivity problem of the client device 202.

Optionally, one or more of the actions defined by one or more of the resolution profile(s) may require approval of the user 204 associated with the client device 202. In such case, the entity executing the set of actions defined by the resolution profile(s), for example, the local IT assistance agent 222, the remote agent 224, and/or the IT assistance engine 220 may prompt the user 204 to request approval of the action prior to executing it. For example, assuming, one or more actions of a certain resolution profile require accessing, retrieving, and/or using private data related to the user 204, for example, credentials, personal information, and/or the like, the user 204 may be asked to approve and/or authorize such actions.

Optionally, the IT assistance engine 220 may store at least part of the system data collected in relation to one or more of the IT issues related to the client device202. In particular, the IT assistance engine 220 may store the system data and/or part thereof in one or more online storage resources accessible via the network 206 to one or more of the technicians 254 using their client devices 252. For example, the IT assistance engine 220 may establish, create, and/or update a ticketing system controlled by one or more ticketing engines which track, collect, and store one or more support tickets comprising data related to the IT issues reported by the client devices 202. The IT assistance engine 220 may further update the support ticket of one or more of the IT issues to include additional data related to the respective IT issue, for example, the solution(s), the resolution profile(s), and/or the set of actions generated, and/or determined by the ML model(s) for resolving the respective IT issue.

Optionally, the IT assistance engine 220 may be further adapted to generate an IT issue summary for one or more IT issues related to the client device 202 based on the system data collected in relation to the respective IT issue. For example, the IT issue summary of one or more IT issues may comprise the system data related to the respective IT issue and/or part thereof. In another example, the IT issue summary of one or more IT issues may further include the solution(s) and/or resolution profile(s) determined, selected and/or generated for resolving the respective IT issue.

Optionally, the IT assistance engine 220 may apply one or more generative ML models, language models, and/or NLP algorithms for generating the IT issue summary of one or more IT issues related to the client device 202.

Each of the client device(s) 252 of the technician(s) 254 may execute one or more software modules comprising and/or exposing a user interface enabling the technicians 254 to view, browse, search, and/or otherwise access the stored data, for example, the system data related to the IT issue, the support ticket, the IT issue summaries, and/or the like. For example, one or more of the client devices 252 used by one or more of the technicians 254 may execute a GUI, for example, a local GUI, a web-based GUI, and/or a combination thereof for enabling the technician(s) 254 to access the stored data.

Optionally, one or more technicians 254 using their client devices 252 may adjust one or more of the resolution profiles generated, and/or determined by the ML model(s) for one or more of the IT issues related to the client device 202. The technician(s) 254 may explore the resolution profile(s) via the GUI, for example, the web-based GUI, and may adjust the resolution profile(s), for example, change one or more actions, remove, add and/or replace one or more of the actions, and/or the like.

Optionally, the IT assistance engine 220 may be adapted to check whether reported IT issue(s) are resolved by the set of actions defined by the resolution profile(s) applied to resolve the issue(s). For example, after the resolution profile(s) are applied to resolve the IT issue(s), the IT assistance engine 220 may collect and analyze additional system data relating and/or indicative of the IT issue(s) to determine, evaluate, and/or confirm the reported IT issue(s) is resolved. For example, assuming a certain reported IT issue related to a network connectivity issue at the client device 202. In such case, after one or more resolution profiles are applied to resolve the issue, the IT assistance engine 220 may collect additional system data indicative of network connectivity of the client device 202 and determine accordingly is the network connectivity issue is resolved or not.

Moreover, in case the reported IT issue(s) is not resolve by the resolution profile(s), the IT assistance engine 220 may optionally generate one or more additional resolution profiles, optionally based on additional system data collected in relation to the IT issue(s), as described in steps 124 and 126 of the process 120, and instruct applying the additional resolution profile(s) as described in steps 110, 130 and/or 146 in attempt to resolve the IT issue(s).

### Block Diagram

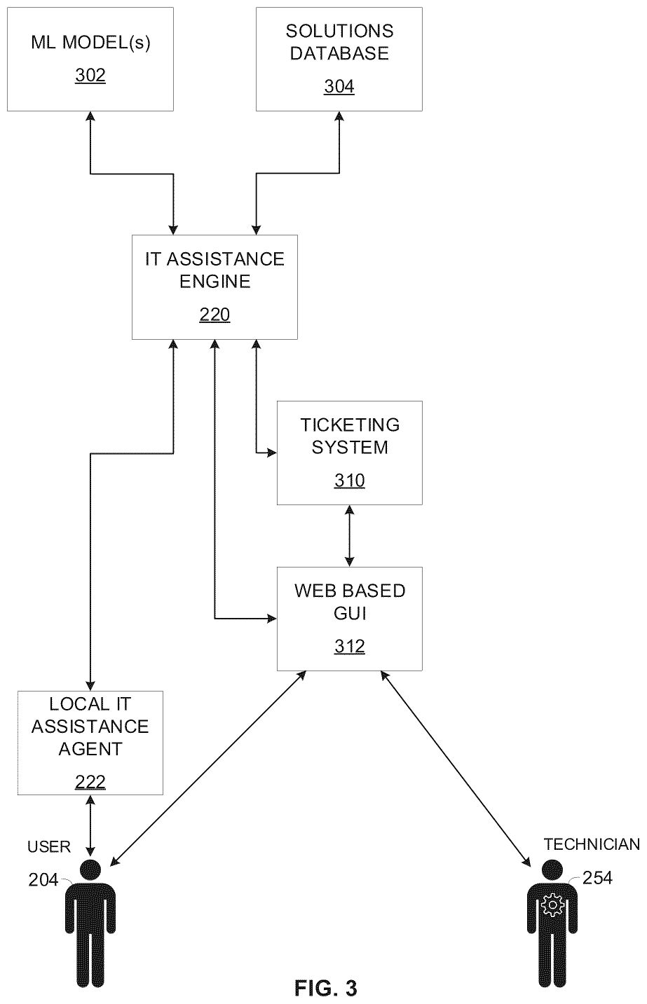

Reference is now made to FIG. 3, which is a schematic illustration of example building blocks of a system for automatically resolving IT issues using machine learning models.

A local IT assistance agent such as the local IT assistance agent 222 may be executed by a client device such as the client device 202 used by an associated user such as the user 204 for resolving one or more IT issues related to the client device 202. In particular, upon detection of one or more IT issues, the local IT assistance agent 222 may request an IT assistance engine such as the IT assistance engine 220 to resolve the identified IT issue(s).

The IT assistance engine 220 executed by an IT assistance system such as the IT assistance system 200 may apply one or more ML models 302 adapted to automatically identify, infer, derive, and/or otherwise determine one or more resolution profiles comprising a set of actions implementing one or more solutions estimated to resolve the IT issue(s) reported by the local IT assistance agent 222.

Optionally, the IT assistance engine 220 and/or ML model(s) 302 may determine one or more solutions according to a solutions database storing possible solutions for a plurality of IT issues which were applied in the past and proved to at least partially resolve the IT issues.

Optionally, the user 204 may interact with the local IT assistance agent 222 and/or the IT assistance engine 220 through a user interface, for example, a GUI, optionally a web-based GUI 312 to provide user input and optionally receive instructions to support resolving the IT issue(s).

Optionally, one or more technicians such as the technician 254 using client devices such as the client device 252 may also interact with the IT assistance engine 220, for example, to assist in resolving one or more IT issues related to one or more client devices 202 used by respective users 204. Typically, the technician(s) 254 may access a ticketing system 310 controlled by one or more ticketing engines which tracks, collects, and stores a plurality of support tickets comprising data related to the IT issues reported by the client devices 202. The technician(s) 254 may therefore retrieve data related to reported IT issues, including active IT issues currently handled and may track, monitor, and/or adjust one or more of the solutions determined by the IT assistance engine 220 for resolving one or more of the logged IT issues.

Optionally, the IT assistance engine 220 may be further adapted to monitor and estimate an operational state (health) of one or more of the plurality of functional components related to one or more of the plurality of client devices 202. The monitored functional components may comprise one or more local functional component such as the functional components 248 of the respective client device 202. In another example, monitored functional components may comprise one or more remote functional components of systems, platforms, and/or services serving the respective client device202. For example, the remote functional components may comprise one or more functional components of one or more of the remote services 210 serving the respective client devices 202. In another example, the remote functional components may comprise one or more functional components of one or more of the infrastructure systems 208 serving the respective client device 202.

To this end, the IT assistance engine 220 may collect system data, for example, informative data related to related to one or more of the client devices, specifically system data related to one or more of functional components related to one or more of the plurality of client devices 202.

The system data (such as, type, scope, parameters, settings, details, etc.) which is collected for the health check evaluation may be predefined, and/or learned by the IT assistance engine 220, specifically by the AI model(s) according to past (historical) system data patterns identified as indicative of proper and/or failed operation of the functional components. Optionally, the system data and/or informative data, for example, type of data, scope of data, operational parameters, settings, details, and/or the like may be adjusted, selected, and/or defined according to an organizational knowledge base established, accumulated and/or learned over time by one or more organizations with which the users 204 and/or client devices 202 are associated, for example, a company, an institute, a firm, and/or the like.

In order to evaluate the operational state of the functional components, the IT assistance engine 220 may collect system data according to one or more operating modes. For example, the IT assistance engine 220 may periodically, continuously, and/or on demand (such as in response to a trigger), collect system data related to one or more of the client devices, specifically system data related to one or more of functional components related to one or more of the plurality of client devices 202.

The IT assistance engine 220 may analyze the collected system data, for example, using one or more ML models, to evaluate whether the monitored functional components operate as expected, for example, according to proper execution patterns, or whether the system data may be indicative of one or more potential failures, IT issues, and/or the like.

In order to effectively monitor and estimate the operational state (health check) of one or more of the plurality of functional components related to the client device 202, the IT assistance engine 220 may need to interact with one or more of the remote agents 224, for example, collect system data used to estimate the operational state, apply one or more actions for resolving one or more potential issues and/or the like. As described herein before, the remote agents 224 may be designed, implemented, and/or deployed to support this operational state evaluation using one or more integration, migration, and/or development methods, techniques, and/or means, for example, a plug-in module, an add-on package, an SDK, and/or the like comprising operational state evaluation monitoring, logic, and/or controls functionality.

The IT assistance engine 220 and the local IT assistance agent 222 may be designed, constructed, deployed, and/or operated according to one or more design architectures, implementations, and/or the like.

### Example System Designs

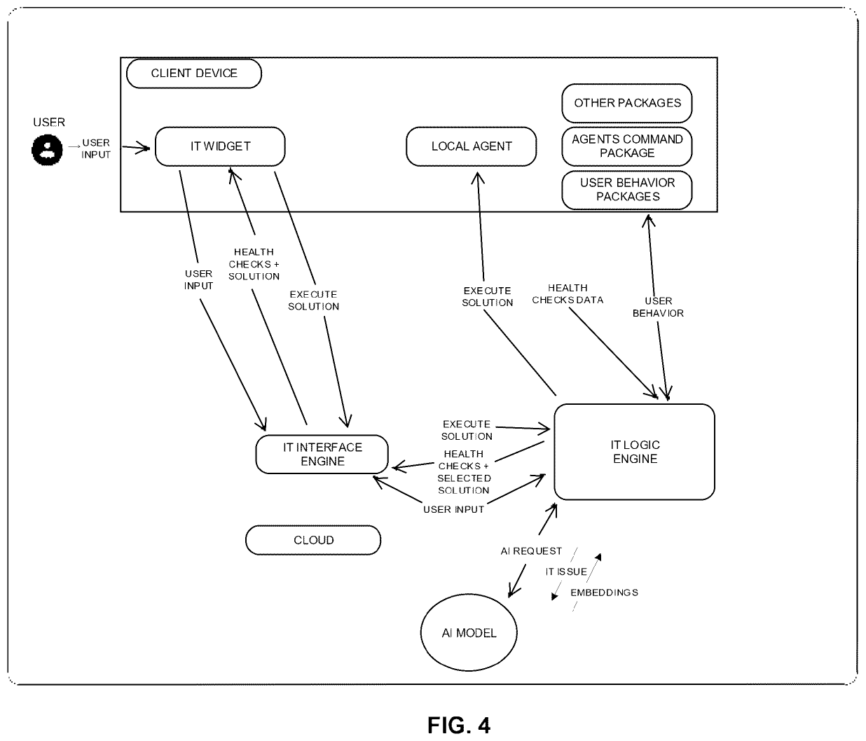

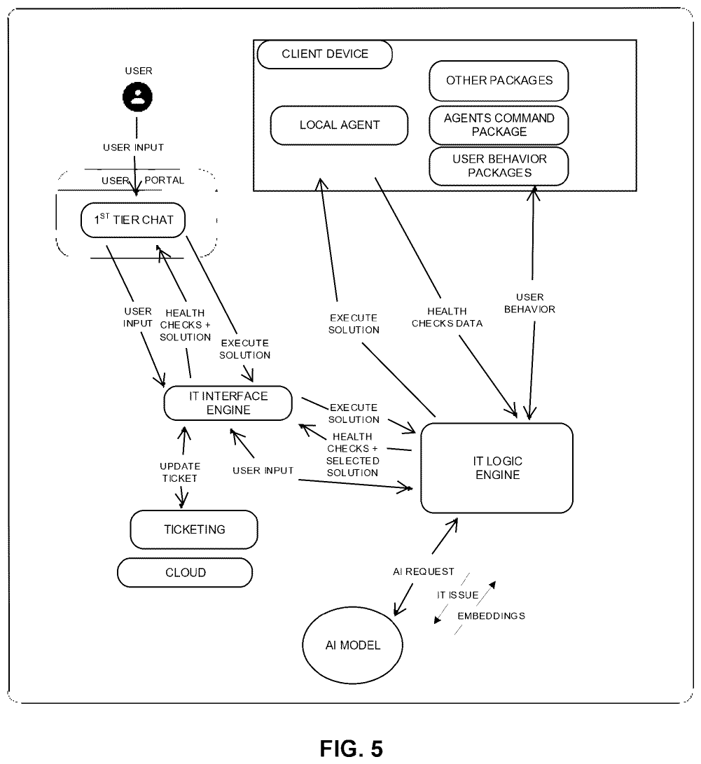

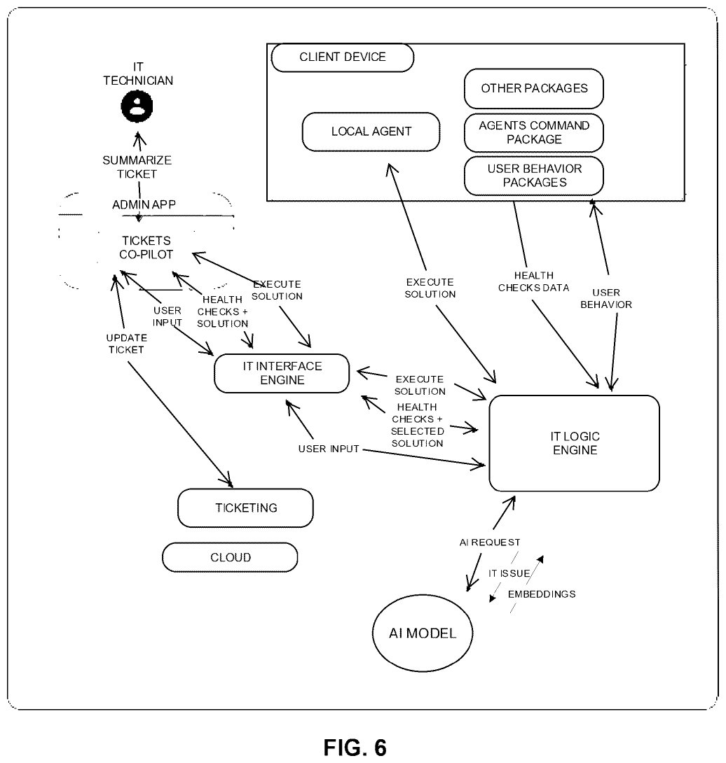

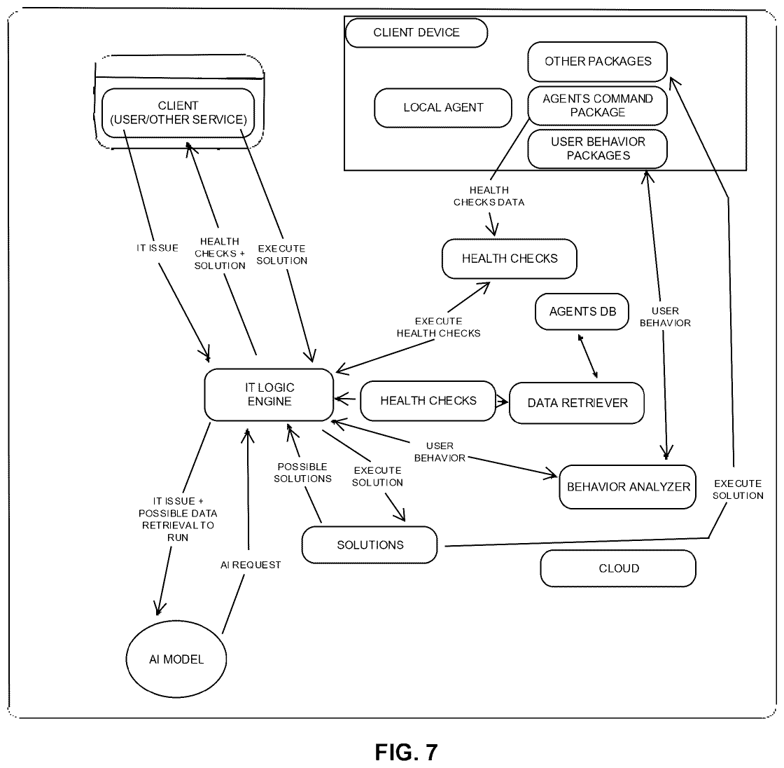

Reference is now made to FIG. 4, FIG. 5, FIG. 6, and FIG. 7, which are schematic illustrations of example designs of a system for automatically resolving IT issues using machine learning models.

As seen in FIG. 4, an example local IT assistance agent such as the local IT assistance agent 222 executed by a client device such as the client device 202 may be implemented using a plurality of functional modules, specifically, software modules, for example, an IT widget, a local agent, an agents command package, a user behavior package and one or more other packages.

The local IT assistance agent 222 may communicate with an example cloud-based IT assistance engine such as the IT assistance engine 220 constructed of a plurality of functional modules, specifically, software modules, for example, an IT interface engine adapted to control interaction with client devices 202 and their associated users such as the user 204, and an IT logic engine comprising the core logic of the IT assistance engine 220.

The IT widget may be adapted to facilitate a user interface, for example, a GUI for interacting with the user 204 to receive user input, specifically user input provided in relation to one or more IT issues related to the client device. The IT widget may be further adapted to transmit the user input provided by the user to a remote instance of IT assistance engine 220, specifically to the IT interface engine facilitating a chat engine driving the GUI interface at the IT widget.

The IT interface engine may be further adapted to deliver, forward and/or transmit the user input to the IT logic engine comprising the core logic of the IT assistance engine 220 and thus adapted to collect system data related to IT issues related to the client device, communicate with one or more AI models such as the ML model 302.

The user behavior package may log interaction of the user with the client device and/or content presented by the client device, specifically user interaction logged in relation to one or more IT issues related to the client device, and transmit the user behavior data to the IT logic engine.

The IT logic engine may collect system data related to one or more IT issues related to the client device, for example, the user input, the user behavior data and also informative data comprising operational data related to one or more functional components of the client device and/or of one or more services serving the client device.

The AI model may be adapted to determine resolution profiles for resolving IT issues related to the client devices based on the system data received from the IT logic engine. In particular, the IT logic engine may issue a query (prompt, request) to the AI model which may comprise the IT issue, specifically the system data related to the IT issue. Based on the received IT issue, the AI model may generate Embeddings which may comprise a feature vector comprising features (values) extracted from the received system data.

The Embeddings, such as, the feature vector generated by the AI model may be used, for example, by the IT logic engine, and/or the AI model to conduct a semantic search in an IT solutions space to identify one or more best matching feature vectors associated with solutions to IT issues. Matching vectors may be indicative that the associated solutions may be applied to solve IT issues characterized and/or mapped by the respective system data.

The IT logic engine may transmit one or more solutions estimated by the AI model to resolve the IT issue, specifically resolution profiles comparing actions implementing the solutions, to the local agent, and/or to the IT widget at the client device which may execute the actions to resolve the IT issue.

As described herein before, the operational state (health) of one or more of the functional components related to the client device may be estimated independently of any IT issues, for example, continuously, periodically and/or in response to a trigger.

To this end, the agents command package may be adapted to collect system data, for example, informative data, user behavior data, and/or the like, independently of IT issues and transmit the collected system data to the IT logic engine. Optionally, the agents command package may collect system data according to instructions of the IT logic engine which may define the system data requirements according to the operational state (health) checks defined for the client device.

Based on the system data received from the agents command package, optionally coupled with user input received from the IT widget, the IT logic engine, optionally using the AI model, may estimate the operational state, such as, the health of one or more of the functional components related to the client device.

As seen in FIG. 5, the user may optionally interact with the cloud-based IT assistance engine, specifically with the IT interface engine via a user portal serving as a 1st tier chat interface rather than via the IT widget executed by the client device. Moreover, the user may access the user portal using a different client device than the one to which the IT issue(s) relate. The AI assistance engine may further maintain a ticketing module, for example, a database, a record, a system, and/or the like storing a plurality of support tickets tracking a plurality of IT issues related to a plurality of client devices. Via the user portal, one or more users may view, browse, check and optionally update one or more of the support tickets.

As seen in FIG. 6, one or more human technicians such as the technician 254 using respective client devices such as the client device 252 may access the IT assistance engine. For example, the technician 254 may launch an admin application on the client device 252 which may execute a ticket co-pilot engine through which the technician may access one or more of the support tickets to track, intervene, and/or follow-up on one or more IT issues.

As seen in FIG. 7, the cloud-based IT assistance engine, specifically the IT logic engine, may be constructed of a plurality of software modules each designed and adapted to execute a respective functionality of the IT logic engine. At least some of the software modules may communicate with each other to transfer data among them. For example, a health checks module may define operational state (health) checks for execution by one or more client devices, optionally also defining the type, scope, etc. of system data to be collected and delivered it to agents command package at the client device(s). In another example, a solutions module may be deployed to identify, determine, and/or select from a solutions space one or more solutions estimated to effectively resolve each IT issue related to the client devices. In another example, a behavior analyzer may be executed to analyze user behavior data logged, for example, by the user behavior package at the client device, to provide insights regarding possible solutions for resolving one or more IT issues related to one or more client devices.

### AI Resolution Profiles and Knowledge Base Framework

In various embodiments, IT issues, IT issue summaries, tickets, root causes, associated tests, and/or associated solutions are stored in a knowledge base. For example, the knowledge base includes a list of tests under “slow internet” such as testing internet connection and testing CPU and memory tests. In various embodiments, the knowledge base is automatically created as described below. In various embodiments, the IT assistance system accesses the knowledge base to determine tests, solutions, and/or other data associated with an IT issue. In various embodiments, the IT assistance system generates resolution profiles based on the knowledge base. In various embodiments, the IT assistance system uses ML models to determine tests to execute and/or data to collect to determine root causes of reported IT issues and to determine solutions based on the knowledge base.

### Specialist AI Agents and Automated Knowledge Base Framework

In various embodiments, the system and method of the present disclosure includes specialist AI agents that are designed to function as a framework which enables the creation of multiple AI-driven agents, which perform specialized tasks and generate actionable deliverables. This framework facilitates the automation of various IT operations, enhancing efficiency, and reducing manual effort. In various embodiments, users (such as technicians 254) can customize each specialist AI agent by defining and configuring flows tailored to specific needs, selecting triggers based on system events, creating actions to execute tasks autonomously, and deploying AI agents that operate continuously, ensuring round-the-clock efficiency.

In various embodiments, the IT assistance system includes AI-driven specialist agents that generate or update knowledge base entries. In various embodiments, the specialist agents generate and execute resolution profiles based on the knowledge base entries. In various embodiments, the specialist agents refine existing knowledge base entries and/or resolution profiles (whether created by the specialist agents or human technicians). In various embodiments, the specialist agents use third-party data to update or refine knowledge base entries and/or resolution profiles.

For example, a specialist agent determines that a knowledge base entry does not meet a threshold level of detail, does not provide a solution to an associated issue, or has not been updated in a threshold amount of time. In response to the determination, the specialist agent performs a web search and ticket search to gather information relevant to the knowledge base entry. After updating the knowledge base entry, the specialist agent refines a resolution profile associated with the knowledge base entry. In various embodiments, the resolution profiles and/or knowledge base entries are stored in a database. In various embodiments, knowledge base entries and/or resolution profiles include a strength metric, which indicates how many service tickets a knowledge base entry and/or resolution profile is derived from. In other words, if a resolution profile is based on a large quantity of tickets that indicate similar issues and solutions, then the probability that the resolution profile solves an issue similar to those described by the tickets is high.

As another example, a flow can be customized to create a knowledge base by automatically identifying useful solutions from closed tickets and automatically creating (or flagging as suggestions) the solutions as knowledge base articles. In various embodiments, a knowledge base flow operates as follows:
1) Trigger: activate the flow when a ticket is closed;
2) Action 1: analyze the ticket's content and determine whether the technician's response provided a solution that could be useful for other end-users;
3) Action 2: verify whether the identified solution already exists in the knowledge base;
4) Action 3: if the solution does not exist, create (or suggest) a knowledge base article.

As another example, a flow can be used to analyze remote sessions conducted by IT technicians and determine whether their actions can be converted into automated scripts. This flow helps streamline IT operations by automating repetitive tasks and reducing manual effort. The flow includes:
1) Trigger: activate the flow when a remote session ends;
2) Action 1: analyze the technician's actions during the remote session;
3) Action 2: determine whether those actions are scriptable and could be useful for future automation;
4) Action 3: verify whether the identified script already exists in the scripts library;
5) Action 4: if the script does not exist, create (or suggest) a new script.

As another example, a flow can be used to aggregate overlapping flows. A flow with a trigger based on when a new flow is created analyzes flows to determine whether multiple entities contain the same identified deliverable. If redundancy is detected, they are aggregated into a single flow.

In various embodiments, a specialist agent triggers multiple sets of actions. For example, a flow includes a first set of actions that resolves an issue (such as slow internet speed). In addition to actions that resolve the slow internet, the flow also includes a set of secondary actions that do not resolve the issue such as creating a service request ticket, tagging a service request ticket, or generating system modifications.

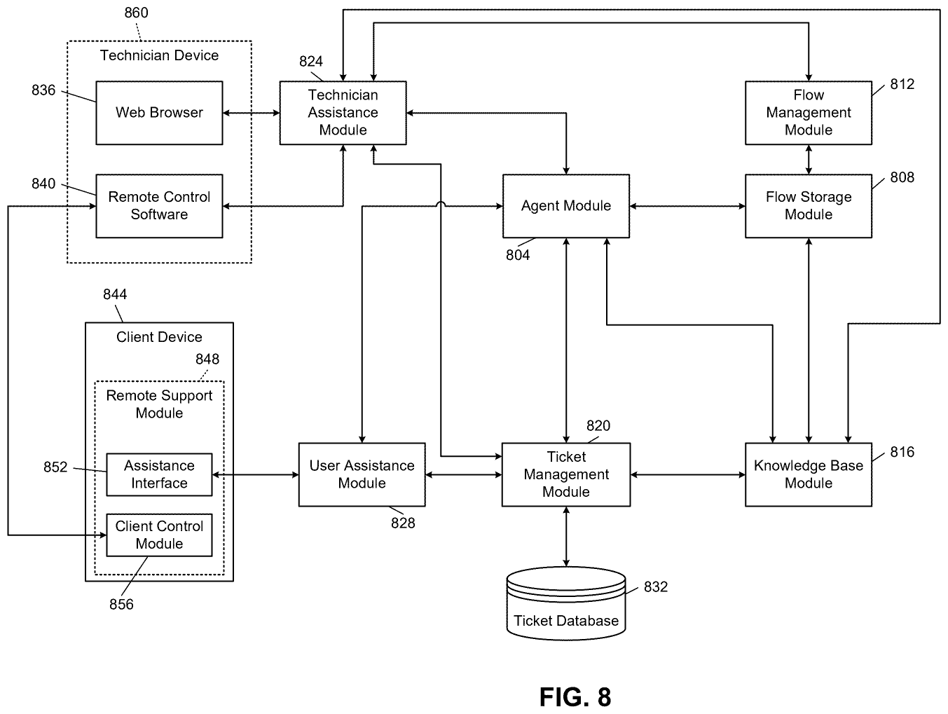

FIG. 8 is a functional block diagram of an example system for managing and creating specialist AI agent flows (for example, flows for automated knowledge base creation). Agent module 804 executes one or more specialist AI agents. In various embodiments, agent module 804 stores one or more LLMs. Agent module 804 communicates with various modules to analyze data, run scripts, and/or generate additional scripts and/or data. Agents are executed on agent module 804 in response to flow storage module 808 detecting a trigger. Flows (including agents, actions, and triggers) can be modified via flow management module 812. A technician user of technician device 860 connects to technician assistance module 824 via web browser 836 (or similar user interface with a network connection). Technician assistance module 824 is used to interact with tickets via ticket management module 820, flows via flow management module 812, client device 844 via remote control software 840, agents via agent module 804, and/or the knowledge base via knowledge base module 816.

Remote support module 848 runs on client device 844 and creates service request tickets. Client device 844 includes client control module 856 which connects to remote control software 840 and assistance interface 852 which communicates with user assistance module 828. User assistance module 828 communicates with ticket management module 820 to create tickets. Agent module 804 communicates with user assistance module 828 to execute agents and/or scripts on client device 844 to resolve a service ticket if an appropriate flow is triggered. Ticket database 832 stores created tickets including open and resolved tickets.

FIG. 9 is a flowchart of an example method for a flow that rates a technician assistance session. Control begins at 904 and determines whether a ticket has been closed (the flow's trigger). If no ticket has been closed, control remains at 904. If a ticket has been closed, control transfers to 908. At 908, control analyzes the communications associated with the ticket (for example, emails, chat logs, screen recordings, and/or voice communications). At 912, a service quality rating is determined via LLM analysis or other criteria. At 914, the ticket is updated with the service quality rating. Control then returns to 904.

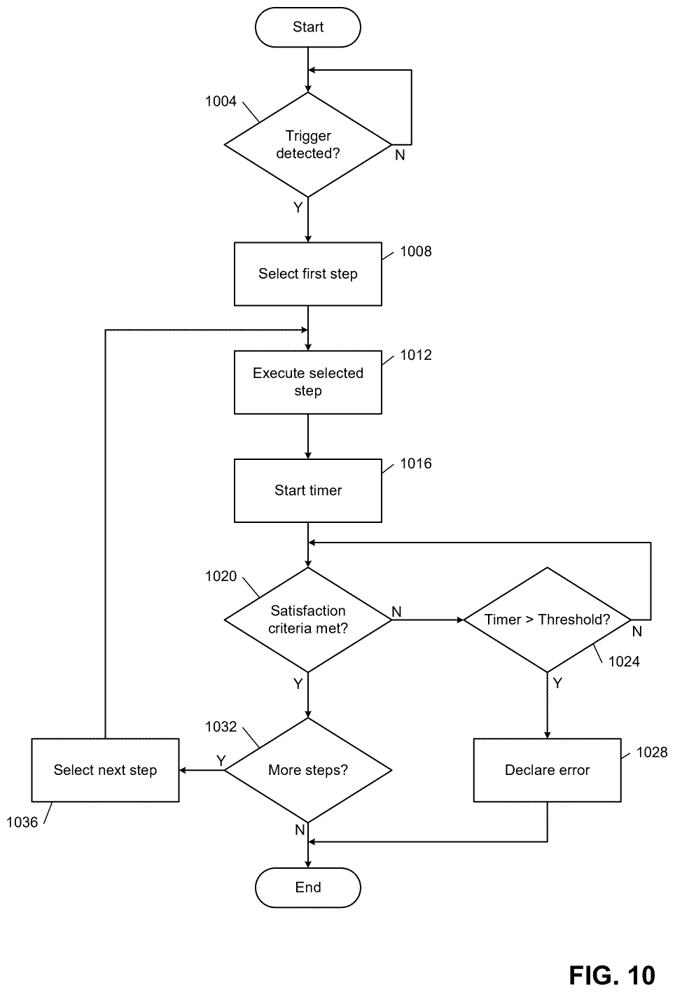

FIG. 10 is a flowchart of an example specialist AI agent flow. Control begins at 1004 and determines whether the flow's trigger has been detected. If the trigger has not been detected, control remains at 1004. If the trigger has been detected, control continues to 1008. At 1008, control selects the first step (or action of the flow). At 1012, control executes the selected step. At 1016, control begins a timer. At 1020, control determines whether the step's satisfaction criteria have been met (for example, has the step completed, changed one or more parameters, or achieved or more results). If the satisfaction criteria have been met, control transfers to 1032. If the satisfaction criteria have not been met, control transfers to 1024.

At 1032, control determines whether there are more steps of the flow that require execution. If there are no remaining steps, control ends. If there are steps remaining, control transfers to 1036 and selects the next step. Control then returns to 1012. At 1024, control determines whether the timer has exceeded a threshold. If the threshold has not been exceeded control transfers to 1020. If the timer has exceeded a threshold, control transfers to 1028 and an error is declared and control ends.

### End-User Interface Example

In various embodiments, a specialist agent is integrated into an end-user chat interface. In various embodiments, the end-user explains a problem via chat, and the specialist agent identifies one or more issues and/or potential solutions (such as a resolution profile) to the reported issue. In various embodiments, the specialist agent triggers one or more scripts and/or resolution profiles to identify a root cause of the reported issue. For example, if slow internet speed is reported, the specialist agent does one or more of the following: i) identifies the issue based on the user's chat text, ii) determines if a knowledge base entry exists for the issue, iii) based on the knowledge base entry, executes a script to test the network speed, iv) executes additional scripts to confirm the issue (such as checking RAM usage or processor capacity), and/or v) executes one or more scripts to resolve the issue based on the knowledge base entry (such as rebooting the computer, restarting a network router, closing programs using large portions of RAM, etc.). In various embodiments, if a knowledge base entry does not exist for the reported issue, the issue may be elevated for technician review. In various embodiments, a knowledge base entry is created based on the technician's response.

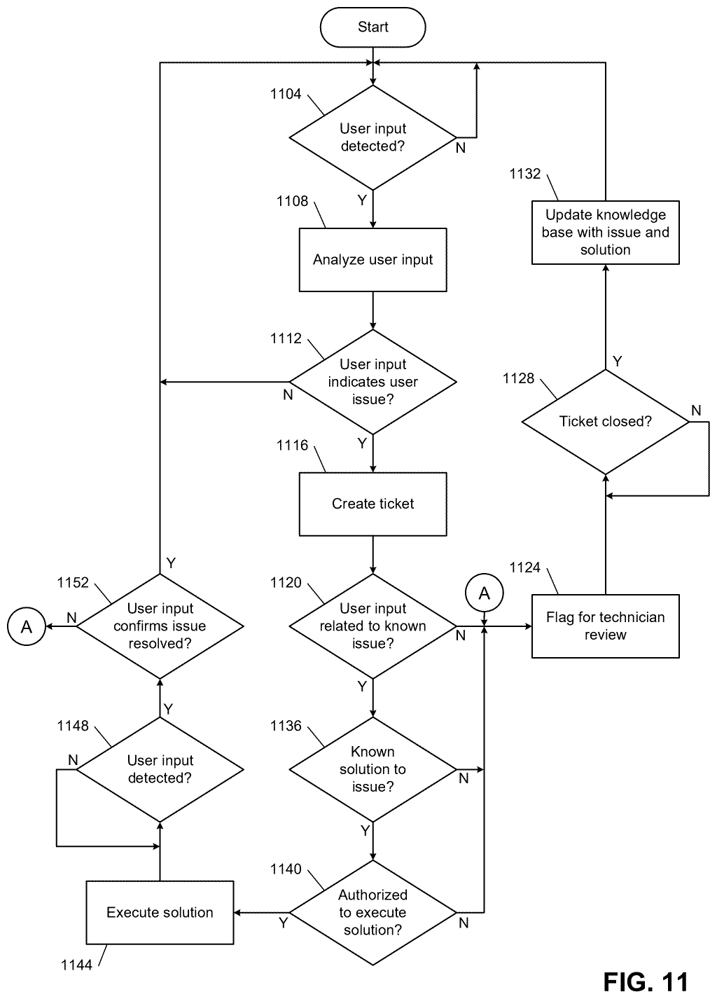

FIG. 11 is a flowchart of an example method for an end-user automation involving a chat interface. Control begins at 1104 and determines whether user input has been detected. If no input has been detected, control remains at 1104. If input is detected, control transfers to 1108. At 1108, control analyzes the user input. At 1112, control determines whether the input indicates a user issue. If no issue is indicated, control returns to 1104. If an issue is indicated, control transfers to 1116. At 1116, control creates a service ticket. At 1120, control determines whether the issue indicated by the user input is related to a known issue (in other words, is there a corresponding knowledge base entry). If the user input is not related to a known issue, control transfers to 1124. If the user input is related to a known issue, control transfers to 1136.

At 1124, control flags the ticket for additional technician review. At 1128, control determines whether the ticket has been closed (in other words, has the technician resolved the issue). If the ticket has not been closed, control remains at 1128. If the ticket has been closed, control transfers to 1132 and control updates the knowledge base with the issue and solution from the technician. Control then returns to 1104.

At 1136, control determines whether there is a known solution (in the knowledge base) to the issue. If there is no known solution, control transfers to 1124. If there is a known solution, control transfers to 1140. At 1140, control determines whether control is authorized to execute the known solution (for example, does the end-user require administrative privileges). If control is not authorized to execute the solution, control transfers to 1124. In various embodiments, authorization includes approval from the end-user. In various embodiments, authorization includes approval from a technician. In various embodiments, executing the solution does not require authorization. If control is authorized to execute the solution, control transfers to 1144. At 1144, control executes the solution. At 1148, control determines whether additional user input has been detected (for example, in response to a prompt to confirm whether the issue has been resolved). If user input has been detected, control transfers to 1152. If user input has not been detected, control remains at 1148. At 1152, control determines whether the user input confirms that the issue has been resolved. If the issue has not been resolved, control transfers to 1124. If the issue has been resolved, control returns to 1104.

### Technician Interface Example

In various embodiments, a specialist agent is integrated into a technician user interface. In various embodiments, the interface displays open tickets (from end-users requesting assistance resolving an issue). In various embodiments, the specialist agent analyzes the tickets to determine the issue, determines whether there is a knowledge base entry associated with the issue, and/or suggests or generates resolution profiles (including scripts, and/or third-party service actions such as making API calls to a second computer system or service and/or executing web-searches) to resolve the issue. In various embodiments, suggested scripts or resolution profiles are stored in a database. In various embodiments, suggested resolution profiles require technician authorization before executing. In various embodiments, suggested resolution profiles do not require technician authorization before executing. In various embodiments, a suggested resolution profile requires authorization after creation to verify the resolution profile, but does not require authorization before executing. In various embodiments, whether a suggested resolution profile requires authorization before executing is determined based on the actions of the resolution profile. For example, a resolution profile resetting a printer may not require authorization, but a resolution profile resetting a server or changing a high-value asset may require authorization.

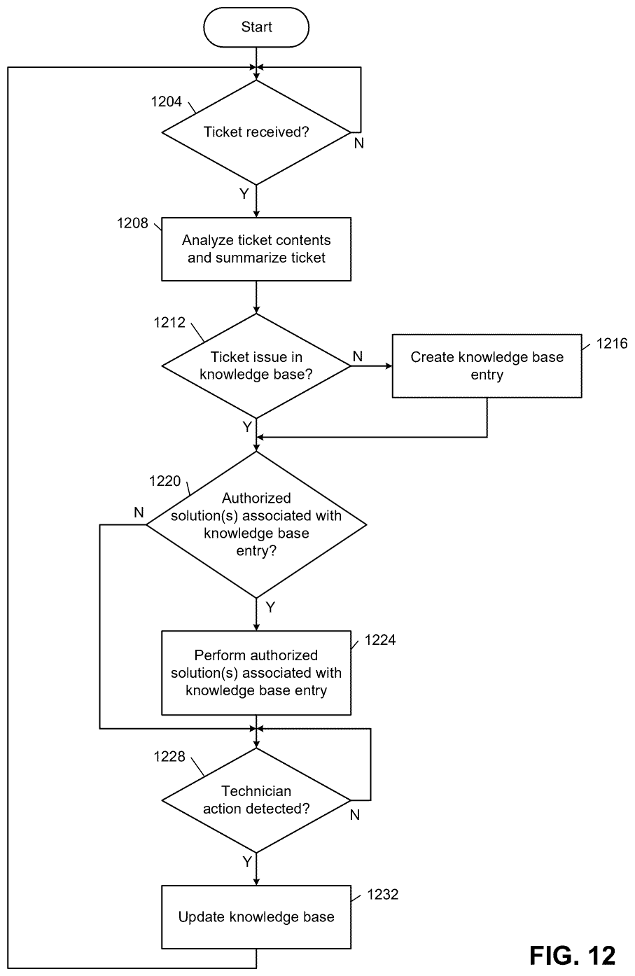

FIG. 12 is a flowchart of an example method for a technician user automation framework. Control begins at 1204 and determines whether a ticket has been received. If no ticket has been received, control remains at 1204. If a ticket has been received, control transfers to 1208. At 1208, control analyzes the ticket contents and context (such as chat logs, user input describing the issue, history and/or tickets from the requesting user). At 1212, control determines whether the issue associated with the ticket has an associated entry in the knowledge base. If there is no associated issue, control transfers to 1216 and creates a new knowledge base entry. If a knowledge base entry exists, control transfers to 1220. At 1220, control determines whether there are authorized solutions associated with the knowledge base entry. If there are no authorized solutions, control transfers to 1228. If there are authorized solutions, control transfers to 1224 and performs the authorized solution.

At 1228, control determines whether technician action has been detected. For example, independent technician action to resolve the issue and/or approval to execute a script or authorized solution. At 1232, the knowledge base entry is updated to include the solution, the issue, that a solution was less effective in resolving an issue, or other notes. Control then returns to 1204.

### CONCLUSION

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “coupled,” and “engaged.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

The term “set” generally means a grouping of one or more elements. The elements of a set do not necessarily need to have any characteristics in common or otherwise belong together. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

In the FIGURES, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgments of, the information to element A.

In this application, including the definitions below, the term “module” can be replaced with the term “controller” or the term “circuit.” In this application, the term “controller” can be replaced with the term “module.” The term “module” may refer to, be part of, or include processor hardware (shared, dedicated, or group) that executes code coupled with memory hardware (shared, dedicated, or group) that stores code executed by the processor hardware.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid-state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

1. A method comprising:
receiving a first user input from a first user associated with a first computer system;
automatically determining, using at least one of a set of machine learning models, whether the first user input indicates a technical issue associated with the first computer system;
automatically determining, using at least one model of the set of machine learning models, whether the technical issue is associated with one or more entries in a database;
in response to a determination that the technical issue is associated with the one or more entries in the database:
automatically identifying at least one action set associated with the technical issue, and
in response to detecting a second input from the first user, coordinating execution of the at least one action set on the first computer system, including remotely executing a series of one or more actions specified by the at least one action set; and
in response to a determination that the technical issue is not associated with the one or more entries in the database:
detecting a third user input from a second user,
recording the third user input,
analyzing, using at least one model of the set of machine learning models, the recording of the third user input, and
creating an entry in the database including a set of data based on the third user input.

2. The method of claim 1, wherein the third user input includes a solution to the technical issue.

3. The method of claim 1, wherein the third user input includes a set of interactions with the first computer system.

4. The method of claim 1, wherein the set of data based on the third user input includes at least one of:
at least a second action set,
a set of communication data associated with the first user and the second user, or
a plain-text description of the third user input.

5. The method of claim 1, wherein the at least one action set includes an executable script or function.

6. The method of claim 1, wherein the at least one action set includes transmitting a set of instructions including a request to execute an executable script or function to a second computer system.

7. The method of claim 1, further comprising:
summarizing, using at least one model of the set of machine learning models, the first user input, and
retrieving a set of historical data related to the first user.

8. The method of claim 1, wherein the technical issue is associated with the one or more entries in the database, the method further comprising determining whether the at least one action set resolved the technical issue.

9. The method of claim 1, wherein the technical issue is not associated with the one or more entries in the database, the method further comprising determining whether the third user input resolved the technical issue.

10. The method of claim 1, wherein the third user input is received via a second computer system with a remote connection to the first computer system.

11. A system comprising:
memory hardware configured to store instructions; and
processor hardware configured to execute the instructions, wherein the instructions include:
receiving a first user input from a first user associated with a first computer system;
automatically determining, using at least one of a set of machine learning models, whether the first user input indicates a technical issue associated with the first computer system;
automatically determining, using at least one model of the set of machine learning models, whether the technical issue is associated with one or more entries in a database;
in response to a determination that the technical issue is associated with the one or more entries in the database:
automatically identifying at least one action set associated with the technical issue, and
in response to detecting a second input from the first user, coordinating execution of the at least one action set on the first computer system, including remotely executing a series of one or more actions specified by the at least one action set; and
in response to a determination that the technical issue is not associated with the one or more entries in the database:
detecting a third user input from a second user,
recording the third user input,
analyzing, using at least one model of the set of machine learning models, the recording of the third user input, and
creating an entry in the database including a set of data based on the third user input.

12. The system of claim 11, wherein:
the third user input includes:
a solution to the technical issue, and
a set of interactions with the first computer system, and
the set of data based on the third user input includes at least one of:
at least a second action set,
a set of communication data associated with the first user and the second user, or
a plain-text description of the third user input.

13. The system of claim 11, wherein:
the at least one action set includes an executable script or function,
wherein the at least one action set includes transmitting a set of instructions including a request to execute an executable script or function to a second computer system.

14. The system of claim 11, wherein the instructions include:
summarizing, using at least one model of the set of machine learning models, the first user input, and
retrieving a set of historical data related to the first user.

15. The system of claim 11, wherein:
the technical issue is associated with the one or more entries in the database, and
the instructions include determining whether the at least one action set resolved the technical issue.

16. A non-transitory computer-readable storage medium storing processor-executable instructions, wherein the instructions include:
receiving a first user input from a first user associated with a first computer system;
automatically determining, using at least one of a set of machine learning models, whether the first user input indicates a technical issue associated with the first computer system;
automatically determining, using at least one model of the set of machine learning models, whether the technical issue is associated with one or more entries in a database;
in response to a determination that the technical issue is associated with the one or more entries in the database:
automatically identifying at least one action set associated with the technical issue, and
in response to detecting a second input from the first user, coordinating execution of the at least one action set on the first computer system, including remotely executing a series of one or more actions specified by the at least one action set; and
in response to a determination that the technical issue is not associated with the one or more entries in the database:
detecting a third user input from a second user,
recording the third user input,
analyzing, using at least one model of the set of machine learning models, the recording of the third user input, and
creating an entry in the database including a set of data based on the third user input.

17. The non-transitory computer-readable storage medium of claim 16, wherein:
the third user input includes:
a solution to the technical issue, and
a set of interactions with the first computer system, and
the set of data based on the third user input includes at least one of:
at least a second action set,
a set of communication data associated with the first user and the second user, or
a plain-text description of the third user input.

18. The non-transitory computer-readable storage medium of claim 16, wherein:
the at least one action set includes an executable script or function,
wherein the at least one action set includes transmitting a set of instructions including a request to execute an executable script or function to a second computer system.

19. The non-transitory computer-readable storage medium of claim 16, wherein the instructions include:
summarizing, using at least one model of the set of machine learning models, the first user input, and
retrieving a set of historical data related to the first user.

20. The non-transitory computer-readable storage medium of claim 16, wherein:
the technical issue is associated with the one or more entries in the database, and
the instructions include determining whether the at least one action set resolved the technical issue.
